(19) United States
(12) Patent Application Publication
(10) Pub. No.: US 2023/0179128 A1
(43) Pub. Date: Jun. 8, 2023

(54) MULTISPEED ALTERNATING CURRENT MACHINE

(71) Applicant: QM Power, Charlotte, NC (US)

(72) Inventors: W. Scott HUNTER, Charlotte, NC (US); Noah TURNER, Charlotte, NC (US); Akshay Surendra KULKARNI, Charlotte, NC (US); Prasanth Kumar SAHU, Charlotte, NC (US); David LEACH, Charlotte, NC (US)

(21) Appl. No.: 18/062,986

(22) Filed: Dec. 7, 2022

Related U.S. Application Data
(60) Provisional application No. 63/286,914, filed on Dec. 7, 2021.
(60) Provisional application No. 63/304,443, filed on Jan. 28, 2022.

(51) Int. Cl. H02P 6/30; H02P 6/182; H02P 6/28

(52) U.S. Cl. CPC H02P 6/30; H02P 6/182; H02P 6/28

(57) ABSTRACT

Systems and methods are for a machine having an alternating current (AC) power source with a first side and a second side, at least one winding, a voltage polarity sensor, a Hall effect sensor, four bi-directional power switches each comprising two DC power switches, and a motor controller. The motor controller is configured to, based on signals from the voltage polarity sensor and the Hall effect sensor, opens or closes or operates with pulse-width modulation the DC power switches to obtain a first direction of current flow through the at least one winding and a second direction of current flow from the first side of the AC power source to the second side of the AC power source or from the second side of the AC power source to the first side of the AC power source.

This application claims the benefit of priority to U.S. Provisional Application No. 63/286,914, filed Dec. 7, 2021, and U.S. Provisional App. No. 63/304,443, filed Jan. 28, 2023, both of which are incorporated herein by reference in their entirety.

### BACKGROUND

In view of the growing proliferation of environmentally friendly laws, enhancements to various classes of motors are required. For example, refrigeration fan motors in a low wattage range, e.g., 4 to 16 watts, used in both the commercial and residential refrigeration markets, have traditionally been low efficiency, such as around 12%-26% efficient. It would be desirable to provide technologies to address enhancements required in different classes of motors.

### SUMMARY

In one aspect, a circuit for a machine having an alternating current (AC) power source with a first side and a second side comprises at least one winding, a voltage polarity sensor, a Hall effect sensor, four bi-directional power switches each comprising two DC power switches, and a motor controller to, based on signals from the voltage polarity sensor and the Hall effect sensor, open or close or operate with pulse-width modulation the DC power switches to obtain a first direction of current flow through the at least one winding and a second direction of current flow from the first side of the AC power source to the second side of the AC power source or from the second side of the AC power source to the first side of the AC power source.

In another aspect, a circuit for a machine having an alternating current (AC) power source having a first side (L1) and a second side (L2) comprises at least one winding with a start side and an end side. A first bi-directional power switch is connected between the first side and the winding start side, the first bi-directional power switch comprising a first DC power switch and a second DC power switch configured in opposite current passing directions. A second bi-directional power switch is connected between the first side and the winding end side, the second bi-directional power switch comprising a third DC power switch and a fourth DC power switch configured in opposite current passing directions. A third bi-directional power switch is connected between the second side and the winding start side, the third bi-directional power switch comprising a fifth DC power switch and a sixth DC power switch configured in opposite current passing directions. A fourth bi-directional power switch is connected between the second side and the winding end side, the fourth bi-directional power switch comprising a seventh DC power switch and an eighth DC power switch configured in opposite current passing directions. The circuit also has a motor controller configured to control the DC power switches to obtain a first direction of current flow through the winding from the start side to the end side or from the end side to the start side and a second direction of current flow from the first side of the AC power source to the second side of the AC power source or from the second side of the AC power source to the first side of the AC power source.

In another aspect, a circuit for a machine having an alternating current (AC) power source having a first side (L1) and a second side (L2) comprises at least one winding with a start side and an end side. A first bi-directional power switch is connected between the first side of the AC power source and the winding start side, the first bi-directional power switch comprising a first DC power switch and a second DC power switch configured in opposite current passing directions. A second bi-directional power switch is connected between the first side of the AC power source and the winding end side, the second bi-directional power switch comprising a third DC power switch and a fourth DC power switch configured in opposite current passing directions. A third bi-directional power switch is connected between the second side of the AC power source and the winding start side, the third bi-directional power switch comprising a fifth DC power switch and a sixth DC power switch configured in opposite current passing directions. A fourth bi-directional power switch is connected between the second side of the AC power source and the winding end side, the fourth bi-directional power switch comprising a seventh DC power switch and an eighth DC power switch configured in opposite current passing directions. The circuit has a Hall effect sensor to detect a position of a rotor of the machine relative to a stator of the machine and output a first signal indicating the position of the rotor relative to the stator a voltage polarity sensor to detect whether voltage from the AC power source is higher at the first side of the AC power source or the second side of the AC power source and output a second signal indicating whether the voltage is higher at the first side of the AC power source or the second side of the AC power source. The circuit also has a motor controller configured to receive the first signal from the Hall effect sensor and the second signal from the voltage polarity sensor, determine based on the first signal and the second signal a first direction of current flow through the winding and a second direction of current flow from the first side of the AC power source to the second side of the AC power source or from the second side of the AC power source to the first side of the AC power source, and control the DC power switches to obtain the determined first direction of current flow through the winding and the determined second direction of current flow from the first side of the AC power source to the second side of the AC power source or from the second side of the AC power source to the first side of the AC power source.

In another aspect, a method for a machine having an alternating current (AC) power source with a first side and a second side comprises providing at least one winding, a voltage polarity sensor, a Hall effect sensor, four bi-directional power switches each comprising two DC power switches, and a motor controller. The motor controller, based on signals from the voltage polarity sensor and the Hall effect sensor, opens or closes or operates with pulse-width modulation the DC power switches to obtain a first direction of current flow through the at least one winding and a second direction of current flow from the first side of the AC power source to the second side of the AC power source or from the second side of the AC power source to the first side of the AC power source.

In another aspect, a method for a machine having an alternating current (AC) power source having a first side (L1) and a second side (L2) comprises providing at least one winding with a start side and an end side. A first bi-directional power switch is provided between the first side and the winding start side, the first bi-directional power switch comprising a first DC power switch and a second DC power switch configured in opposite current passing directions. A second bi-directional power switch is provided between the first side and the winding end side, the second bi-directional power switch comprising a third DC power switch and a fourth DC power switch configured in opposite current passing directions. A third bi-directional power switch is provided between the second side and the winding start side, the third bi-directional power switch comprising a fifth DC power switch and a sixth DC power switch configured in opposite current passing directions. A fourth bi-directional power switch is provided between the second side and the winding end side, the fourth bi-directional power switch comprising a seventh DC power switch and an eighth DC power switch configured in opposite current passing directions. The method also includes providing a motor controller to control the DC power switches to obtain a first direction of current flow through the winding from the start side to the end side or from the end side to the start side and a second direction of current flow from the first side of the AC power source to the second side of the AC power source or from the second side of the AC power source to the first side of the AC power source.

In another aspect, a method for a machine having an alternating current (AC) power source having a first side (L1) and a second side (L2) comprises providing at least one winding with a start side and an end side. A first bi-directional power switch is provided between the first side of the AC power source and the winding start side, the first bi-directional power switch comprising a first DC power switch and a second DC power switch configured in opposite current passing directions. A second bi-directional power switch is provided between the first side of the AC power source and the winding end side, the second bi directional power switch comprising a third DC power switch and a fourth DC power switch configured in opposite current passing directions. A third bi-directional power switch is provided between the second side of the AC power source and the winding start side, the third bi-directional power switch comprising a fifth DC power switch and a sixth DC power switch configured in opposite current passing directions. A fourth bi-directional power switch is provided between the second side of the AC power source and the winding end side, the fourth bi-directional power switch comprising a seventh DC power switch and an eighth DC power switch configured in opposite current passing directions. The method includes providing a Hall effect sensor to detect a position of a rotor of the machine relative to a stator of the machine and output a first signal indicating the position of the rotor relative to the stator a voltage polarity sensor to detect whether voltage from the AC power source is higher at the first side of the AC power source or the second side of the AC power source and output a second signal indicating whether the voltage is higher at the first side of the AC power source or the second side of the AC power source. The method also includes providing a motor controller to receive the first signal from the Hall effect sensor and the second signal from the voltage polarity sensor, determine based on the first signal and the second signal a first direction of current flow through the winding and a second direction of current flow from the first side of the AC power source to the second side of the AC power source or from the second side of the AC power source to the first side of the AC power source, and control the DC power switches to obtain the determined first direction of current flow through the winding and the determined second direction of current flow from the first side of the AC power source to the second side of the AC power source or from the second side of the AC power source to the first side of the AC power source.

In another aspect, a method is for a machine having an alternating current (AC) power source with a first side and a second side. In a circuit comprises at least one winding, a voltage polarity sensor, a Hall effect sensor, four bi-directional power switches each comprising two DC power switches, and a motor controller, the method comprises the motor controller opening or closing or operating with pulse-width modulation the DC power switches to obtain a first direction of current flow through the at least one winding and a second direction of current flow from the first side of the AC power source to the second side of the AC power source or from the second side of the AC power source to the first side of the AC power source.

In another aspect, a method is for a machine having an alternating current (AC) power source having a first side (L1) and a second side (L2). In a circuit comprising at least one winding with a start side and an end side, a first bi-directional power switch connected between the first side and the winding start side, the first bi-directional power switch comprising a first DC power switch and a second DC power switch configured in opposite current passing directions, a second bi-directional power switch connected between the first side and the winding end side, the second bi-directional power switch comprising a third DC power switch and a fourth DC power switch configured in opposite current passing directions, a third bi-directional power switch connected between the second side and the winding start side, the third bi-directional power switch comprising a fifth DC power switch and a sixth DC power switch configured in opposite current passing directions, a fourth bi-directional power switch connected between the second side and the winding end side, the fourth bi-directional power switch comprising a seventh DC power switch and an eighth DC power switch configured in opposite current passing directions, and a motor controller, the method comprises controlling the DC power switches to obtain a first direction of current flow through the winding from the start side to the end side or from the end side to the start side and a second direction of current flow from the first side of the AC power source to the second side of the AC power source or from the second side of the AC power source to the first side of the AC power source.

In another aspect, a method is for a machine having an alternating current (AC) power source having a first side (L1) and a second side (L2). In a circuit comprising at least one winding with a start side and an end side, a first bi-directional power switch connected between the first side of the AC power source and the winding start side, the first bi-directional power switch comprising a first DC power switch and a second DC power switch configured in opposite current passing directions, a second bi-directional power switch connected between the first side of the AC power source and the winding end side, the second bi directional power switch comprising a third DC power switch and a fourth DC power switch configured in opposite current passing directions, a third bi-directional power switch connected between the second side of the AC power source and the winding start side, the third bi directional power switch comprising a fifth DC power switch and a sixth DC power switch configured in opposite current passing directions, a fourth bi-directional power switch connected between the second side of the AC power source and the winding end side, the fourth bi-directional power switch comprising a seventh DC power switch and an eighth DC power switch configured in opposite current passing directions, a Hall effect sensor to detect a position of a rotor of the machine relative to a stator of the machine and output a first signal indicating the position of the rotor relative to the stator, a voltage polarity sensor to detect whether voltage from the AC power source is higher at the first side of the AC power source or the second side of the AC power source and output a second signal indicating whether the voltage is higher at the first side of the AC power source or the second side of the AC power source, and a motor controller, the method includes the motor controller receiving the first signal from the Hall effect sensor and the second signal from the voltage polarity sensor, determining based on the first signal and the second signal a first direction of current flow through the winding and a second direction of current flow from the first side of the AC power source to the second side of the AC power source or from the second side of the AC power source to the first side of the AC power source, and controlling the DC power switches to obtain the determined first direction of current flow through the winding and the determined second direction of current flow from the first side of the AC power source to the second side of the AC power source or from the second side of the AC power source to the first side of the AC power source.

In another aspect, a method for operating an induction machine having an alternating current (AC) power source with a first side and a second side. In a circuit comprises at least one winding, a voltage polarity sensor, an output frequency reference, four bi directional power switches each comprising two DC power switches, and a motor controller, the method comprises the motor controller opening or closing or operating with pulse-width modulation the DC power switches to obtain a first direction of current flow through at least one winding and a second direction of current flow from the first side of the AC power source to the second side of the AC power source or from the second side of the AC power source to the first side of the AC power source. The motor controller uses the output frequency reference, which can be generated either through software or hardware, and the pulse-width modulation to vary the output frequency and magnitude of the alternating current flowing through at least one winding of the induction machine by implementing voltage/frequency (V/F) control. The motor controller uses the output frequency reference as a substitute to the hall effect sensor in this application to determine the rate of change in the output alternating current. The ratio of the output frequency reference divided by the input AC frequency is also applied to the input voltage. For ex., if the input AC power source is a 60 Hz 230 Vrms supply and the output frequency reference was set to 30 Hz, the pulse-width modulation would be utilized to create a 30 Hz 115 Vrms output through the induction machine winding which will allow the induction machine to operate at half of the rated speed. The ability to utilize V/F control allows the circuit to act as a variable frequency drive for operating induction machines.

### BRIEF DESCRIPTION OF THE DRAWINGS

FIG. 1 depicts an exemplary embodiment of a motor.

FIG. 2 depicts an exemplary embodiment of a single phase electronically commutated motor (ECM).

FIG. 3 depicts an exemplary embodiment of a multispeed alternating current (AC) machine circuit.

FIG. 4 depicts an exemplary embodiment of control circuit for a multispeed alternating current (AC) machine circuit.

FIG. 5 depicts a mode of operation of a multispeed alternating current (AC) machine circuit.

FIG. 6 depicts another mode of operation of a multispeed alternating current (AC) machine circuit.

FIG. 7 depicts another mode of operation of a multispeed alternating current (AC) machine circuit.

FIG. 8 depicts another mode of operation of a multispeed alternating current (AC) machine circuit.

FIG. 9 depicts another exemplary embodiment of a multispeed alternating current (AC) machine circuit.

FIGS. 10-11 depict an exemplary embodiment of a motor.

FIG. 12 depicts an exemplary embodiment of another motor.

FIG. 13 depicts an exemplary embodiment of windings of teeth of a stator connected in series.

FIG. 14 depicts an exemplary embodiment of windings of teeth of a stator connected in parallel.

FIG. 15 depicts an exemplary embodiment of a voltage polarity sensor.

FIGS. 16-18 depict an exemplary embodiment of a current sensor circuit.

FIG. 19 depicts another exemplary embodiment of a multispeed alternating current (AC) machine circuit.

FIG. 20 depicts another exemplary embodiment of a multispeed alternating current (AC) machine circuit.

FIG. 21 depicts another exemplary embodiment of a multispeed alternating current (AC) machine circuit.

FIG. 22 depicts another embodiment of a multispeed alternating current (AC) machine circuit.

FIG. 23 depicts an exemplary embodiment of a clamp circuit for motor voltage.

FIG. 24 depicts another exemplary embodiment of a clamp circuit for motor voltage.

### DETAILED DESCRIPTION

New and useful circuits are disclosed that provide advantages over the prior art for controlling motors. The circuits in the present disclosure can be used in a variety of motors, such as direct current brushless permanent magnet motors, electronically communicated motors (ECMs), shaded pole motors, other synchronous motors, and permanent-split capacitor (PSC) motors, etc.

FIG. 1 depicts a motor 102 with motor phase windings 104, a motor switches circuit 106, and a motor control circuit 108. The motor 102 includes a stator 110 and a rotor 112 mounted on a shaft 114. The rotor 112 is mounted for rotation in a core structure, such as a laminated core structure or other core structure. The rotor 112 has a body portion, which is shown as cylindrical in shape. The motor 102 includes one or more windings or pairs of windings wound around teeth of the stator 110. The motor 102 has a first side input connection or lead (L1 or Line 1) to an alternating current (AC) power source and a second side input connection or lead (L2 or Line 2) to the AC power source.

The control circuit 108 has a motor controller that controls operation of the motor 102 based on one or more inputs from one or more sensors, including a Hall effect sensor device and a voltage polarity sensor. The sensors detect operations and/or status of the motor 102.

The Hall effect sensor device senses rotor position by sensing a magnetic polarity of a magnetic pole of the rotor and generates either a high output signal or a low output signal that is relative to the magnetic polarity of the magnetic pole of the rotor. For example, the Hall effect sensor device may generate a high output signal when it senses a north magnetic pole and may generate a low output signal when it senses a south magnetic pole. In one example, the Hall effect sensor device is mounted inside a holder that attaches to the stator or a mount of the motor 102. The Hall effect sensor device holder keeps a face of the Hall effect sensor device just inside of the edge of the magnet attached to the rotor and aligned with the stator.

The voltage polarity sensor detects whether the voltage from an alternating current (AC) power source is higher at the first input connection or lead (L1 or Line 1) to the AC power source or the second input connection or lead (L2 or Line 2) to the AC power source and outputs a signal indicating which of L1 or L2 has the higher voltage. For example, the voltage polarity sensor may generate a signal indicating whether the voltage at L1 is higher or lower than the voltage at L2. In another example, the voltage polarity sensor may generate a high output signal when the voltage at L1 is higher than the voltage at L2 and may generate a low output signal when the voltage at L1 is lower than the voltage at L2.

The motor controller receives the signals from the Hall effect sensor device and the voltage polarity sensor and determines one or more direct current (DC) power switches to turn on, turn off, or operate in pulse width modulation (PWM) mode. The motor controller then transmits one or more control signals to one or more DC power switches to cause the one or more DC power switches to turn on, turn off, or operate in PWM mode. Alternately, the motor controller does not transmit one or more control signals to enable one or more DC power switches to remain on, off, or operating in PWM mode.

In one aspect, if a DC power switch is on and is to remain on, the motor controller does not transmit one or more control signals to the DC power switch to turn the DC power switch on. In another aspect, if a DC power switch is on and is to remain on, the motor controller does transmit one or more control signals to the DC power switch to turn the DC power switch on. In another aspect, if a DC power switch is off and is to remain off, the motor controller does not transmit one or more control signals to the DC power switch to turn the DC power switch off. In another aspect, if a DC power switch is off and is to remain off, the motor controller does transmit one or more control signals to the DC power switch to turn the DC power switch off. In another aspect, if a DC power switch is in PWM mode and is to remain in PWM mode, the motor controller does not transmit one or more control signals to the DC power switch to operate the DC power switch in PWM mode. In another aspect, if a DC power switch is in PWM mode and is to remain in PWM mode, the motor controller does transmit one or more control signals to the DC power switch to operate the DC power switch in PWM mode.

The motor controller according to the present disclosure may be configured to transmit a plurality of control signals to the DC power switches to control the DC power switches to obtain the determined first direction of current flow through the winding and the determined second direction of current flow from the first side of the AC power source to the second side of the AC power source or from the second side of the AC power source to the first side of the AC power source.

The motor 102 can operate below, at, or above synchronous speeds. This is due to the fact that fractions of half cycles can flow through the motor windings.

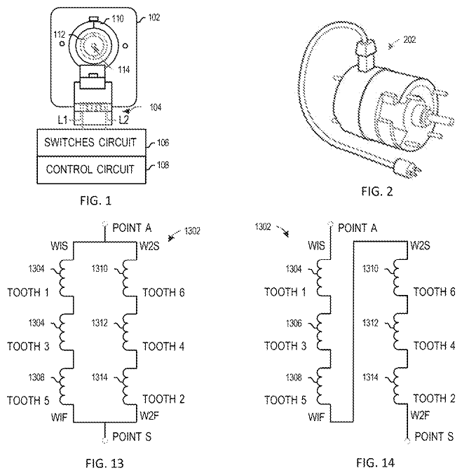

As another example, FIG. 2 depicts a single phase ECM 202 with motor windings, DC power switches, and a motor controller. The motor controller controls operation of the DC power switches to cause current to flow through one or more of the motor windings.

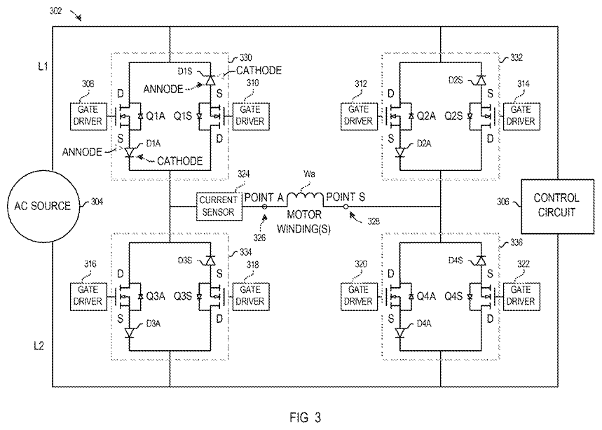

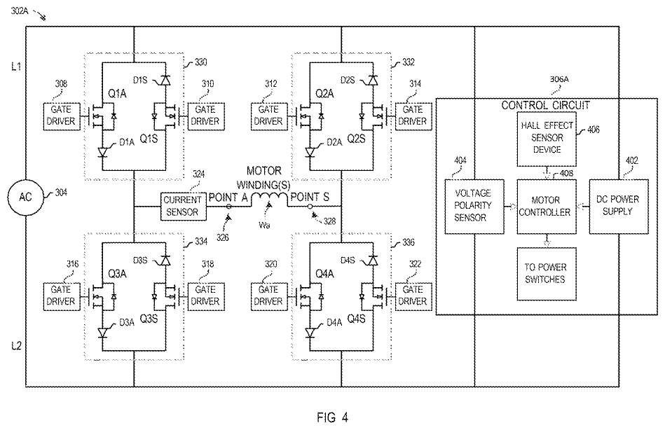

FIGS. 3-4 depict examples of a multispeed alternating current (AC) circuit for a machine. The machine may be a motor or a generator. The multispeed AC circuit may have one, two, three, four, or more windings.

FIG. 3 depicts an example of a multispeed AC machine circuit 302 for a machine. The multispeed AC machine circuit 302 has eight DC power switches, including Q1A (first DC power switch), Q1B (second DC power switch), Q2A (third DC power switch), Q2B (fourth DC power switch), Q3A (fifth DC power switch), Q3B (sixth DC power switch), Q4A (seventh DC power switch), and Q4B (eighth DC power switch). The multispeed AC machine circuit 302 has eight diodes, including D1A (first diode), D1B (second diode), D2A (third diode), D2B (fourth diode), D3A (fifth diode), D3B (sixth diode), D4A (seventh diode), and D4B (eighth diode). The multispeed AC machine circuit 302 also has one or more stator windings Wa, and an alternating current (AC) power source 304 with a first line voltage side at connection or lead L1 (or Line 1) and a second line voltage side at connection or lead L2 (or Line 2), a control circuit 306 to control the DC power switches Q1A, Q1B, Q2A, Q2B, Q3A, Q3B, Q4A, and Q4B at gates/gate drivers 308-322 of the DC power switches and an optional current sensor 324. The one or more windings are connected between a point A 326 and a point B 328.

The drain of the first DC power switch Q1A is connected to L1 and the cathode of the second diode D1B, and the source of the first DC power switch Q1A is connected to the anode of the first diode D1A. The drain of the second DC power switch Q1B is connected to the drain of the fifth DC power switch Q3A, the cathode of the first diode D1A, the cathode of the sixth diode D3B, and the first side of the current sensor. If the optional current sensor 324 is not present, the drain of the second DC power switch Q1B, the drain of the fifth DC power switch Q3A, the cathode of the first diode D1A, and the cathode of the sixth diode D3B all connect to the first side of the windings Wa and point A 326. The source of the second DC power switch Q1B is connected to the anode of the second diode D1B.

The drain of the third DC power switch Q2A is connected to L1 and the cathode of the fourth diode D1B, and the source of the third DC power switch Q2A is connected to the anode of the third diode D2A. The drain of the fourth DC power switch Q2B is connected to the drain of the seventh DC power switch Q7A, the cathode of the third diode D2A, the cathode of the eighth diode D4B, and the second side of the motor windings Wa at point B 328. The source of the fourth DC power switch Q2B is connected to the anode of the fourth diode D2B.

The drain of the fifth DC power switch Q3A is connected to the drain of the second DC power switch Q1B, the cathode of the first diode D1A, the cathode of the sixth diode D3B, and the first side of the current sensor. If the optional current sensor 324 is not present, the drain of the second DC power switch Q1B, the drain of the fifth DC power switch Q3A, the cathode of the first diode D1A, and the cathode of the sixth diode D3B all connect to the first side of the windings Wa and point A 326. The source of the fifth DC power switch Q3A is connected to the anode of the fifth diode D3A. The source of the sixth DC power switch Q3B is connected to the anode of the sixth diode D3B. The drain of the sixth DC power switch Q3B is connected to L2 and the cathode of the fifth diode D3A.

The drain of the seventh DC power switch Q4A is connected to the drain of the fourth DC power switch Q2B, the cathode of the third diode D2A, the cathode of the eight diode D4B, and the second side of the motor windings at point B 328. The source of the seventh DC power switch Q4A is connected to the anode of the seventh diode D4A. The drain of the eighth DC power switch Q4B is connected to the cathode of the seventh diode D4A and L2. The source of the eighth DC power switch is connected to the anode of the eighth diode D4B.

The DC power switches Q1A, Q1B, Q2A, Q2B, Q3A, Q3B, Q4A, and Q4B receive a control signal from the control circuit 306 at their gates/gate drivers 308-322. If the control signal is high or 1, the DC power switches Q1A, Q1B, Q2A, Q2B, Q3A, Q3B, Q4A, and Q4B turn on or close. If the control signal is low or 0, the DC power switches Q1A, Q1B, Q2A, Q2B, Q3A, Q3B, Q4A, and Q4B turn off or open.

The first and second DC power switches Q1A (through diode D1A)/Q1B (through diode D1B) connect point A 326 to L1, and fifth and sixth DC power switches Q3A (through diode D3A)/Q3B (through diode D3B) connect point A to L2. The third and fourth DC power switches Q2A (through diode D2A)/Q2B (through diode D2B) connect point B 328 to L1, and seventh and eighth DC power switches Q4A (through diode D4A)/Q4B (through diode D4B) connect point B to L2.

The one or more motor windings Wa are connected on a first side of the windings at point A to the second side of the current sensor 324 that is connected between the second and fifth DC power switches Q1B/Q3A and the first and sixth diodes D1A/D3B. If the current sensor 324 is not present, the one or more windings Wa are connected on the first side of the windings at point A 326 to the drain of the second DC power switch Q1B, the drain of the fifth DC power switch Q3A, the cathode of the first diode FAA, and the cathode of the sixth diode D3B. The one or more motor windings Wa are connected on a second side at point B 328 that also is a connection point of drains of the fourth and seventh DC power switches Q2B/Q4A and the cathodes of the third and eighth diodes D2A/D4B. point A 3508 is the start side of the one or more motor windings Wa, and point B 3510 is the end side of the one or more motor windings.

The current sensor 324 is connected on a first side at the connection point of the drains of the second and fifth DC power switches Q1B/Q3A and the cathodes of the first and sixth diodes D1A/D3B. The current sensor 324 is connected on a second side to point A 326, which is one connection point to the one or more motor windings Wa. Since current is always flowing through the one or more windings Wa, a single current sensor 324 at this location will provide an accurate current measurement through the one or more windings Wa. The current measurement is transmitted from the current sensor 324 to the control circuit 306. This current measurement may be used to either sense current zero crossings or detect over current situations and used by the control circuit 306, for example for start-up and other operations as described herein. The current sensor 324 is optional in some embodiments.

In the example of FIG. 3, the DC power switches Q1A, Q1B, Q2A, Q2B, Q3A, Q3B, Q4A, and Q48 are single directional DC power switches allowing current to flow from L1 through their respective diodes to L2 or from L2 through their respective diodes to L1. In the example of FIG. 3, the DC power switches Q1A, Q1B, Q2A, Q2B, Q3A, Q3B, Q4A, and Q4B may be high speed solid state relays (QSSRs) that include a metal oxide semiconductor field-effect transistor (MOSFET) that each are configured with one diode D1A, D1B, D2A, D2B, D3A, D3B, D4A, and D4B, respectively. Other types of DC power switches may be used in other examples, such as a switching device or combination of switching devices that allow for the switching of alternating current, including metal-oxide-semiconductor field-effect transistors (MOSFETs), silicon-controlled rectifiers (SCRs), insulated-gate bipolar transistors (IGBTs), or transistors configured to operate as AC switches, for example when placed in series in opposite directions with diodes, or relays or another combination of switches that can be configured for switching alternating current.

The diodes D1A, D1B, D2A, D2B, D3A, D3B, D4A, and D4B ensure current flows in the correct direction through the DC power switches by blocking the current from flowing in the wrong direction. Current flows from the anode of a diode to the cathode of the diode, but not from the cathode of the diode to the anode of the diode. When a DC power switch Q1A, Q1B, Q2A, Q2B, Q3A, Q3B, Q4A, or 048 is energized, AC current flows from one side of the switch to the other side of the switch and through a corresponding diode from the anode to the cathode of the diode. For example, the diodes D1A, D2A, D3A, and D4A allow current to flow from L1 to L2 through the DC power switches Q1A, Q2A, Q3A, and Q4A, respectively. The diodes D1B, D2B, D3B, and D4B allow current to flow from L2 to L1 through the DC power switches Q1B, Q2B, Q3B, and Q4B, respectively.

In the example of FIG. 3, the eight DC power switches Q1A, Q1B, Q2A, Q2B, Q3A, Q3B, Q4A, and Q4B and eight diodes D1A, D1B, D2A, D2B, D3A, D3B, D4A, and D4B are configured into four AC bi-directional power switches Q1 330, Q2 332, Q3 334, and Q4 336, respectively, by arranging two DC power switches and the DC power switch's corresponding diodes in parallel facing opposite current passing directions. For example, the first DC power switch Q1A and its first diode D1A are configured in parallel with the second DC power switch Q1B and its second diode D1B, but the direction of current passing through the first DC power switch Q1A and its first diode D1A is opposite of the direction of current passing through the second DC power switch Q1B and its second diode D1B, with the drain and source of the first DC power switch Q1A facing the opposite direction of the source and drain of the second DC power switch Q1B. Thus, the first DC power switch Q1A and its diode D1A are configured in parallel and in the opposite direction as the second DC power switch Q1B and its diode D1B to form a first AC bi-directional power switch Q1 330. If the proper gate voltage is applied to the gate 308 of the first DC power switch Q1A (e.g., with a high control signal), turning it on, current is able to be passed from L1 through the first DC power switch Q1A and the first diode D1A to point A 326. If the proper gate voltage is applied to the gate 310 of the second DC power switch Q1B (e.g., with a high control signal), turning it on, current is able to be passed from point A 326 through the second DC power switch Q1B and the second diode D1B back to Line 1. If the first DC power switch Q1A and the second DC power switch Q1B both have the proper voltage applied to their gates 308 and 310 (e.g., with high control signals), turning them on, then both DC power switches are capable of passing current in their respective directions, effectively creating the first bi-directional power switch Q1 330.

Similarly, the third DC power switch Q2A and its diode D2A are configured in parallel and in the opposite current passing direction as the fourth DC power switch Q2B and its diode D2B (with the drains and sources of the DC power switches facing the opposite directions) to form a second AC bi-directional power switch Q2 332. If the proper gate voltage is applied to the gate 312 of the third DC power switch Q2A (e.g., with a high control signal) (e.g., with a high control signal), turning it on, current is able to be passed from L1 through the third DC power switch Q2A and the third diode D2A to point B 328. If the proper gate voltage is applied to the gate 314 of the fourth DC power switch Q2B (e.g., with a high control signal), turning it on, current is able to be passed from point B 328 through the fourth DC power switch Q12B and the fourth diode D2B back to Line 1. If the third DC power switch Q2A and the fourth DC power switch Q2B both have the proper voltage applied to their gates 312 and 314 (e.g., with high control signals), turning them on, then both DC power switches are capable of passing current in their respective directions effectively creating the second AC bi-directional power switch Q1 332.

The fifth DC power switch Q3A and its diode D3A are configured in parallel and in the opposite current passing direction as the sixth DC power switch Q3B and its diode D3B (with the drains and sources of the DC power switches facing the opposite directions) to form a third AC bi-directional power switch Q3 334. If the proper gate voltage is applied to the gate 316 of the fifth DC power switch Q3A (e.g., with a high control signal), turning it on, current is able to be passed from point A 326 through the fifth DC power switch Q3A and the first diode D3A to Line 2. If the proper gate voltage is applied to the gate 318 of the sixth DC power switch Q3B (e.g., with a high control signal), turning it on, current is able to be passed from Line 2 through the sixth DC power switch Q3B and the sixth diode D3B to point A 326. If the fifth DC power switch Q3A and the sixth DC power switch Q3B both have the proper voltage applied to their gates 318 and 320 (e.g., with high control signals), turning them on, then both DC power switches are capable of passing current in their respective directions effectively creating the third AC bi-directional power switch Q3 334.

The seventh DC power switch Q4A and its diode D4A are configured in parallel and in the opposite current passing direction as the eighth DC power switch Q4B and its diode D4B (with the drains and sources of the DC power switches facing the opposite directions) to form a fourth AC bi-directional power switch Q4 336. If the proper gate voltage is applied to the gate 320 of the seventh DC power switch Q6A (e.g., with a high control signal), turning it on, current is able to be passed from point B 328 through the seventh DC power switch Q4A and the seventh diode D4A to Line 2. If the proper gate voltage is applied to the gate 322 of the eighth DC power switch Q48 (e.g., with a high control signal), turning it on, current is able to be passed from Line 2 through the eighth DC power switch Q4B and the eighth diode D4B to point B 328. If the seventh DC power switch Q4A and the eighth DC power switch Q4B both have the proper voltage applied to their gates 320 and 322 (e.g., with high control signals), turning them on, then both DC power switches are capable of passing current in their respective directions effectively creating the fourth AC bi-directional power switch Q4 336.

Because the bi-directional power switches Q1 330, Q2 332, Q3 334, and Q4 336 include two opposite facing DC power switches Q1A/Q1B, Q2A/Q2B, Q3A/Q3B, and Q4A/Q4B, respectively, both DC power switches Q1A/Q1B, Q2A/Q2B, Q3A/Q3B, or Q4A/Q4B that make up a bi-directional power switch can be on at the same time to pass current in both directions, both DC power switches that make up a bi-directional power switch can be off at the same time to not pass current in either direction, a first one of the DC power switches that make up a bi-directional power switch can be on to pass current in a first direction while the second one of the DC power switches that make up a bi-directional power switch is off and not passing current in the second direction that is opposite of the first direction, or the second DC power switch can be on to pass current in the second direction while the first DC power switch is off and not passing current in the first direction that is opposite of the second direction. This structure is an advantage in switching operations over only single directional switches and enables smoother current to continue flowing in a selected direction while the DC power switches are turned on and off and operated in PWM mode. Since the bi-directional power switches Q1 330, Q2 332, Q3 334, and Q4 336 enable current to flow in both directions through the bi-directional power switches, current can continue flowing through the windings Wa in the same direction of flow when a pair of bi-directional switches Q1/Q4 or Q2/Q3 are closed (thus turned on) while the motor controller of the control circuit 306 is opening, closing, and placing in PWM mode one or more other DC power switches Q1A, Q1B, Q2A, Q2B, Q3A, Q3B, Q4A, and Q4B and until the switching operations are complete for the DC power switches in a particular mode of operation. In some embodiments, turning on/closing a pair of bi-directional switches Q1/Q4 or Q2/Q3 while the motor controller of the control circuit 306 is opening, closing, and placing in PWM mode one or more other DC power switches Q1A, Q1B, Q2A, Q2B, Q3A, Q3B, Q4A, and Q4B facilitates changing current direction. This structure also provides greater switching options than single directional switches and switches that only provide bi-directional power switching but do not also provide single directional switching.

The DC power switches Q1A, Q1B, Q2A, Q2B, Q3A, Q3B, Q4A, and Q4B and their diodes D1A, D1B, D2A, D2B, D3A, D3B, D4A, and D4B are configured in an H-Bridge configuration with the windings Wa. The DC power switches Q1A, Q1B, Q3A, and Q3B and their diodes D1A, D1B, D3A, and D3B form a first outer leg of the H-Bridge, the DC power switches Q2A, Q2B, Q4A, and Q4B and their diodes D2A, D2B, D4A, and D4B form a second outer leg of the H-Bridge, and the motor windings Wa and the optional current sensor 324 are configured as a connection or middle leg between the two outer legs and connecting the two outer legs. Similarly, the first and third bi-directional power switches 330 and 334 form a first outer leg of the H-Bridge, the second and fourth bi-directional power switches 332 and 336 form a second outer leg of the H-Bridge, and the motor windings Wa and the optional current sensor 324 are configured as a connection or middle leg between the two outer legs and connecting the two outer legs.

An open DC power switch Q1A, Q1B, Q2A, Q2B, Q3A, Q3B, Q4A, and/or Q4B (or Q1, Q2, Q3, and Q4) is off and turns off in response to a control signal (e.g., a low control signal) from the control circuit 306. A closed DC power switch Q1A, Q1B, Q2A, Q2B, Q3A, Q3B, Q4A, and/or Q4B (or Q1, Q2, Q3, and Q4) is on and turns on in response to a control signal (e.g., a high control signal) from the control circuit 306. A DC power switch Q1A, Q1B, Q2A, Q2B, Q3A, Q3B, Q4A, and/or Q4B in pulse-width modulation (PWM) mode repeatedly turns on for a first period of time during a total period of time and turns off for a second period of time during the total period of time to result in an output voltage in response to one or more PWM control signals transmitted to the DC power switch from the control circuit 306. For example, a DC power switch in PWM mode turns on for a first period of time in response to the DC power switch receiving a first PWM control signal (e.g., a high PWM control signal) from the control circuit 306 and turns off for a second period of time in response to the DC power switch receiving a second PWM control signal (e.g., a low PWM control signal) from the motor controller. The control circuit 306 repeatedly transmits the first (e.g., high) and second (e.g., low) control signals to the DC power switch Q1A, Q1B, Q2A, Q2B, Q3A, Q3B, Q4A, and/or Q4B to cause the DC power switch to repeatedly turn on and off during the total period of time. The total period of time (also referred to as an on-off cycle) is the on-period of time (also referred to as the pulse active time or on-cycle) plus the off-period of time (referred to as the off-cycle). The on-period of time compared to the total period of time often is referred to as a duty-cycle. Duty cycle is commonly expressed as a percentage or a ratio of the on-period of time divided by the total period of time. The on-period of time of the DC power switch Q1A, Q1B, Q2A, Q2B, Q3A, Q3B, Q4A, and/or Q4B can be increased compared to the off-period of time of the DC power switch to result in a higher output voltage of the DC power switch or the on-period of time of the DC power switch can be decreased compared to the off-period of time of the DC power switch to decrease the output voltage of the DC power switch.

The motor controller may be configured to continuously determine an actual duty cycle at one of the DC power switches and compare the actual duty cycle with a desired duty cycle. The motor controller may increase or decrease an on-period or off-period of time of one of the DC power switches to achieve the desired duty cycle.

Having PWM mode on for one DC power switch Q1A, Q1B, Q2A, Q2B, Q3A, Q3B, Q4A, or Q4B while having two other DC power switches on results in three DC power switches being on during a PWM high control signal and two DC power switches on during a PWM low control signal, which allows current to continue circulating through the windings Wa without interruption to prevent large inductive switching spikes in the multispeed AC machine circuit 302 when the PWM control signal is low and the corresponding DC power switch is off. Having PWM mode on for one DC power switch Q1A, Q1B, Q2A, Q2B, Q3A, Q3B, Q4A, or Q4B while having two other DC power switches on or switching on also allows current to continue circulating through the windings Wa to prevent large inductive switching spikes in the multispeed AC machine circuit 302 when switching between modes of operation. For example, when switching various DC power switches Q1A, Q1B, Q2A, Q2B, Q3A, Q3B, Q4A, and/or Q4B on and off, there is a path for current to continue to flow through the windings Wa without interruption when one DC power switch is in PWM mode.

For example, the DC power switches switches Q1A, Q1B, Q2A, Q2B, Q3A, Q3B, Q4A, and/or Q4B may be arranged to pass current from Line 1, through point B 328 and the windings Wa, to point A 326 and out to Line 2 by turning on the second DC power switch Q1B and the third DC power switch Q2A and leaving them on while operating the fifth DC power switch Q3A in PWM mode. When the PWM control signal to the fifth DC power switch Q3A is high and the fifth DC power switch Q3A is therefore on, current is passed from Line 1 through the third DC power switch Q2A, through point B 328 and the windings Wa, to point A 326, and out to Line 2 by passing through the fifth DC power switch Q3A. When the PWM control signal to the fifth DC power switch Q3A is low and the fifth DC power switch Q3A is therefore off, the second DC power switch Q1B and the second diode D1B act as a freewheeling diode to allow current to continue circulating through the windings Wa to prevent large inductive switching spikes.

The control circuit 306 controls operation of the multispeed AC machine circuit 302. The control circuit 306 determines which one or more of the DC power switches Q1A, Q1B, Q2A, Q2B, Q3A, Q3B, Q4A, and/or Q4B to open (and therefore turn off), close (and therefore turn on), or operate in PWM mode to obtain the proper direction of current flow from Line 1 or Line 2 and through the one or more windings Wa in the multispeed AC machine circuit 302 and then opens one or more DC power switches by transmitting a low control signal to the DC power switches (thereby turning the one or more DC power switches off), doses one or more DC power switches by transmitting a high control signal to the DC power switches (thereby turning the one or more DC power switches on), and controls one or more DC power switches in PWM mode. The control circuit 306 controls a DC power switch Q1A, Q1B, Q2A, Q2B, Q3A, Q3B, Q4A, and/or Q4B in PWM mode by repeatedly turning a DC power switch on for a first period of time (by sending a high control signal to the DC power switch) and turning the DC power switch off for a second period of time (by sending a low control signal to the DC power switch) at a selected duty cycle and for a total selected length of time to result in a first output voltage. The control circuit 306 may increase the on-period of time DC power switch Q1A, Q1B, Q2A, Q2B, Q3A, Q3B, Q4A, and/or Q4B compared to the off-period of time of the DC power switch to result in a higher output voltage or decrease the on-period of time of the DC power switch compared to the off-period of time of the DC power switch to decrease the output voltage.

The control circuit 306 opens one or more DC power switches Q1A, Q1B, Q2A, Q2B, Q3A, Q3B, Q4A, and Q4B by transmitting a low control signal to the one or more DC power switches (thereby turning the one or more DC power switches off), closes one or more DC power switches by transmitting a high control signal to the one or more DC power switches (thereby turning the one or more DC power switches on), and controls one or more DC power switches in PWM mode by repeatedly transmitting high and low control signals to the one or more DC power switches at a selected duty cycle and for a total period of time. The control circuit 306 opens the one or more DC power switches Q1A, Q1B, Q2A, Q2B, Q3A, Q3B, Q4A, and Q4B, closes the one or more DC power switches, and operates one or more DC power switches in PWM mode during startup and off-synchronous operation. Off-synchronous operation is operation of the machine at less than synchronous speed or greater than synchronous speed.

In one example, the control circuit 306 opens the first, fourth, sixth, seventh, and eighth DC power switches Q1A, Q2B, Q3B, Q4A, and Q48, closes the second and third DC power switches Q1B and Q2A, and operates the fifth DC power switch Q3A in PWM mode to cause current to flow from the first side lead L1, through the windings Wa, and to the second side lead L2 at a selected output voltage. In addition, current flows from the windings Wa through the second DC power switch Q1B and back to the first side lead L1.

In another example, the control circuit 306 opens the first, third, fourth, sixth, and seventh DC power switches Q1A, Q2A, Q2B, Q3B, and Q4A, closes the fifth and eighth DC power switches Q3A and Q4B, and operates the second DC power switch Q1B in PWM mode to cause current to flow from the second side lead L2, through the windings Wa, and to the first side lead L1 at a selected output voltage. In addition, current flows from the windings Wa through the fifth DC power switch Q3A and back to the second side lead L2.

In another example, the control circuit 306 opens the second, third, fifth, sixth, and eighth DC power switches Q1B, Q2A, Q3A, Q3B, and Q4B, closes the first and fourth, DC power switches Q1A and Q2B, and operates the seventh DC power switch Q4A in PWM mode to cause current to flow from the first side lead L1, through the windings Wa, and to the second side lead L2 at a selected output voltage. In addition, current flows from the windings Wa through the fourth DC power switch Q2B and back to the first side lead L1.

In another example, the control circuit 306 opens the first, second, third, fifth, and eighth DC power switches Q1A, Q1B, Q2A, Q3A, and Q4B, closes sixth and seventh DC power switches Q3B and Q4A, and operates the fourth DC power switch Q2B in PWM mode to cause current to flow from the second side lead L2, through the windings Wa, and to the first side lead L1 at a selected output voltage. In addition, current flows from the windings Wa through the seventh DC power switch Q4A and back to the second side lead L2.

In one example, the control circuit 306 includes a hardware processor with software executing one or more instructions stored on a non-transitory computer readable storage medium associated with the hardware processor. The non-transitory computer readable storage medium also may have data storage to store data, such as values of one or more sensor signals, values of line voltages, and/or other data. In another example, the control circuit 306 includes a digital signal processor (DSP), an application specific integrated circuit (ASIC), a field programmable gate array signal (FPGA) or other programmable logic device (PLD), discrete gate or transistor logic, discrete hardware components, or combinations thereof designed to perform the functions described herein.

FIG. 4 depicts an example of a control circuit 306A for a multispeed AC machine circuit 302. The control circuit 306A for a motor includes a direct current (DC) power supply 402, an alternating current (AC) voltage polarity sensor 404, a Hall effect sensor device 406, and a motor controller 408. The motor controller 408 can be replaced with a machine controller with the same components as the motor controller to control a generator.

The DC power supply 402 is connected between L1 and L2. The DC power supply 402 converts the incoming AC power to DC power at a DC voltage configured to power the DC powered components in the control circuit 306A, such as the Hall effect sensor device 406 and the motor controller 408. The DC power supply 402 then supplies power to the DC powered components in the control circuit 306A, such as the Hall effect sensor device 406 and the motor controller 408. In one example, the DC power supply 402 includes an IC Offline Converter in a buck topology to convert power from the incoming AC power to low voltage DC power. This low voltage DC power is used to power, and is supplied to, one or more DC powered devices in the control circuit 306A, such as the Hall effect sensor device 406 and the motor controller 408.

The voltage polarity sensor 404 is connected between L1 and L2. The voltage polarity sensor 404 detects or senses whether the voltage is higher at L1 or L2 and outputs a voltage polarity sensor signal indicating which of L1 or L2 has the higher voltage, such as indicating whether the voltage at L1 is higher or lower than the voltage at L2. In one example, if the voltage polarity sensor 404 detects the voltage at L1 is higher than the voltage at L2, the voltage polarity sensor outputs a voltage polarity sensor signal that is high or 1, meaning voltage on L1 is higher than L2. In this example, if the voltage polarity sensor 404 detects the voltage at L1 is lower than the voltage at L2, the voltage polarity sensor outputs a voltage polarity sensor signal that is low or 0, meaning voltage on L1 is less than the voltage on L2.

The Hall effect sensor device 406 detects or senses the position of the rotor relative to the stator and outputs one or more Hall effect position signals indicating the position of the rotor relative to the stator. In one example, the Hall effect sensor device 406 is a bi-polar digital position sensor that detects or senses a polarity of a magnetic pole of the rotor relative to a stator tooth. In this example, the Hall effect sensor device 406 outputs a high Hall effect sensor signal (or 1 for the Hall effect sensor signal) or a low Hall effect sensor signal (or 0 for the Hall effect sensor signal) that is determined by the polarity of the magnetic pole it is sensing. In one example, the Hall effect sensor device 406 outputs (1) a high Hall effect sensor signal (or 1 for the Hall effect sensor signal) indicating a north magnetic pole is facing the stator or (2) a low Hall effect sensor signal (or 0 for the Hall effect sensor signal) indicating a south magnetic pole is facing the stator.

In one example, the location of the Hall effect sensor device 406 relative to the stator results in the Hall effect sensor device outputting a high output or 1 for the Hall effect sensor signal when the back electromotive force (BEMF) of the motor is high and a low output or 0 for the Hall effect sensor signal when the BEMF is low. The BEMF is generated by the combination of the rotor magnets on the spinning rotor passing by the stator teeth with the windings. The BEMF is determined, in one example, by the speed of the rotor and the number of turns on each pole.

The motor controller 408 controls operation of the multispeed AC machine circuit 302. The motor controller 408 determines which one or more of the DC power switches Q1A, Q1B, Q2A, Q2B, Q3A, Q3B, Q4A, and Q4B to open (and therefore turn off), close (and therefore turn on), and/or operate in PWM mode to obtain a first direction of current flow through the one or more windings Wa in the multispeed AC machine circuit 302 from point A 326 to point B 328 or from point B to point A and to obtain a second direction of current flow either from Line 1 to Line 2 or from Line 2 to Line 1 and then opens one or more DC power switches by transmitting a low control signal to the DC power switches (thereby turning the one or more DC power switches off), closes one or more DC power switches by transmitting a high control signal to the DC power switches (thereby turning the one or more DC power switches on), and controls one or more DC power switches in PWM mode to achieve the first direction of current flow and the second direction of current flow. The motor controller 408 controls a DC power switch Q1A, Q1B, Q2A, Q2B, Q3A, Q3B, Q4A, and/or Q4B in PWM mode by repeatedly turning a DC power switch on for a first period of time (by sending a high control signal to the DC power switch) and turning the DC power switch off for a second period of time (by sending a low control signal to the DC power switch) at a selected duty cycle and for a total selected period of time to result in a first output voltage. The motor controller 408 may increase the on-period of time of the DC power switch compared to the off-period of time of the DC power switch to result in a higher output voltage or decrease the on-period of time of the DC power switch compared to the off-period of time of the DC power switch to decrease the output voltage.

The motor controller 408 opens one or more DC power switches Q1A, Q1B, Q2A, Q2B, Q3A, Q3B, Q4A, and Q4B by transmitting a low (e.g., 0) control signal to the gate driver 308-322 of the one or more DC power switches (thereby turning the one or more DC power switches off), closes one or more DC power switches by transmitting a high (e.g., 1) control signal to the gate driver of the one or more DC power switches (thereby turning the one or more DC power switches on), and controls one or more DC power switches in PWM mode by repeatedly transmitting high and low control signals to the gate driver of the one or more DC power switches at a selected duty cycle and for a total period of time. The DC power switches Q1A, Q1B, Q2A, Q2B, Q3A, Q3B, Q4A, and Q4B receive the control signals from the motor controller 408 at their gates/gate drivers 308-322 and turn on/close if the control signal is high (e.g., 1) or turn off/open if the control signal is low (e.g., 0).

The motor controller 408 opens the one or more DC power switches Q1A, Q1B, Q2A, Q2B, Q3A, Q3B, Q4A, and Q4B, closes the one or more DC power switches, and operates the one or more DC power switches in PWM mode during startup and off-synchronous operation. Off-synchronous operation is operation of the motor at less than synchronous speed or greater than synchronous speed.

The motor controller 408 opens one or more bi-directional power switches Q1 330, Q2 332, Q2 334, and Q4 336 by transmitting a low (e.g., 0) signal to the gate drivers 308-322 of both DC power switches in the bi-directional power switch (thereby turning off both of the DC power switches in the bi-directional power switch) and closes one or more bi-directional power switches by transmitting a high (e.g., 1) signal to the gate drivers of both of the DC power switches in the bi-directional power switch (thereby turning on both of the DC power switches in the bi-directional power switch). The motor controller 408 opens one pair of bi directional power switches Q1 330/Q4 336 (the first and fourth bi-directional power switches) or Q2 332/Q3 334 (the second and third bi-directional power switches) and closes the one other pair of bi-directional power switches Q2/Q3 (the second and third bi-directional power switches) or Q1/Q4 (the first and fourth bi-directional power switches) during synchronous operation.

In some embodiments, since the bi-directional power switches Q1 330, Q2 332, Q3 334, and Q4 336 enable current to flow in both directions through the bi-directional power switches, current can continue flowing through the windings Wa in the same direction of flow when the motor controller 408 closes a pair of bi-directional switches Q1/Q4 or Q2/Q3 (thus turning them on) while the motor controller is opening, closing, and placing in PWM mode one or more other DC power switches Q1A, Q1B, Q2A, Q2B, Q3A, Q3B, Q4A, and Q4B and until the switching operations are complete for the DC power switches in a particular mode of operation. In other embodiments, turning on/closing a pair of bi-directional switches Q1 330/Q4 334 or Q2 332/Q3 336 while the motor controller 408 is opening, closing, and placing in PWM mode one or more other DC power switches Q1A, Q1B, Q2A, Q2B, Q3A, Q3B, Q4A, and Q4B during switching operations between one or more modes facilitates changing current direction in the multispeed AC machine circuit 302. Examples of both are described below.

In one example, the motor controller 408 receives a voltage polarity sensor signal from the voltage polarity sensor 404, receives a Hall effect sensor signal from the Hall effect sensor device 406, and determines which one or more of the DC power switches Q1A, Q1B, Q2A, Q2B, Q3A, Q3B, Q4A, and Q4B to open, close, or operate in PWM mode based on a value of the voltage polarity sensor signal and a value of the Hall effect sensor signal to cause the current flow through the one or more windings Wa in a first direction from point A 326 to point B 328 or from point B to point A in the multispeed AC machine circuit 302 and to cause current to flow in a second direction from Line 1 to Line 2 or from Line 2 to Line 1 in the multispeed AC machine circuit. In one example, when the Hall effect sensor signal is low (e.g., has a value of 0), the motor controller 408 transmits control signals to the DC power switches Q1A, Q1B, Q2A, Q2B, Q3A, Q3B, Q4A, and/or Q4B (e.g., to open or close the DC power switches or operate the DC power switches in PWM mode) to cause current to flow in a first direction through the winding Wa from point B 328 to point A 326. In this example, when the Hall effect sensor signal is high (e.g., has a value of 1), the motor controller 408 transmits control signals to the DC power switches Q1A, Q1B, Q2A, Q2B, Q3A, Q3B, Q4A, and/or Q4B (e.g., to open or close the DC power switches or operate the DC power switches in PWM mode) to cause current to flow through the winding Wa in a first direction from point A 326 to point B 328. In one example, when the voltage polarity sensor signal is low (e.g., has a value of 0), the motor controller 408 transmits control signals to the DC power switches Q1A, Q1B, Q2A, Q2B, Q3A, Q3B, Q4A, and/or Q4B (e.g., to open or close the DC power switches or operate the DC power switches in PWM mode) to cause current to flow in a second direction from Line 1 to Line 2. In this example, when the voltage polarity sensor signal is high (e.g., has a value of 1), the motor controller 408 transmits control signals to the DC power switches Q1A, Q1B, Q2A, Q2B, Q3A, Q3B, Q4A, and/or Q4B (e.g., to open or close the DC power switches or operate the DC power switches in PWM mode) to cause current to flow in a second direction from Line 2 to Line 1. The motor controller may increase an advance value of the Hall effect sensor signal, or Hall effect signal.

In one embodiment, the motor controller 408 turns the DC power switches Q1A, Q1B, Q2A, Q2B, Q3A, Q3B, Q4A, and Q4B on and/or off and/or operates the DC power switches in PWM mode in a first switching mode (mode 1) when the voltage polarity sensor signal is low (e.g., has a value of 0) and the Hall effect sensor signal is low (e.g., has a value of 0). The motor controller 408 turns the DC power switches Q1A, Q1B, Q2A, Q2B, Q3A, Q3B, Q4A, and Q4B on and/or off and/or operates the DC power switches in PWM mode in a second switching mode (mode 2) when the voltage polarity sensor signal is high (e.g., has a value of 1) and the Hall effect sensor signal is low (e.g., has a value of 0). The motor controller 408 turns the DC power switches Q1A, Q1B, Q2A, Q2B, Q3A, Q3B, Q4A, and Q4B on and/or off and/or operates the DC power switches in PWM mode in a third switching mode (mode 3) when the voltage polarity sensor signal is low (e.g., has a value of 0) and the Hall effect sensor signal is high (e.g., has a value of 1). The motor controller 408 turns the DC power switches Q1A, Q1B, Q2A, Q2B, Q3A, Q3B, Q4A, and Q4B on and/or off and/or operates the DC power switches in PWM mode in a fourth switching mode (mode 4) when the voltage polarity sensor signal is high (e.g., has a value of 1) and the Hall effect sensor signal is high (e.g., has a value of 1). The motor controller may be configured to change a switching mode to drive current in the winding down to zero. The motor controller may change a switching mode or change between switching modes.

The motor controller 408 may control (e.g., open or close) one switch in a bi directional power switch but not control the other switch in the same bi-directional power switch. Additionally, the motor controller 408 may control (e.g., open or close) both switches in a bi-directional power switch. Any combination of open and closed configurations of the switches can be achieved, such as one switch being open while the other closed, both switches open, and/or both switches closed.

In one example, such as in mode 1 when the voltage polarity sensor signal is low (e.g., has a value of 0) and the Hall effect sensor signal is low (e.g., has a value of 0), the motor controller 408 transmits control signals (e.g., low or 0 control signals) to the first, fourth, sixth, seventh, and eighth DC power switches Q1A, Q2B, Q3B, Q4A, and Q4B to open the first, fourth, sixth, seventh, and eighth DC power switches Q1A, Q2B, Q3B, Q4A, and Q4B, transmits control signals (e.g., high or 1 control signals) to the second and third DC power switches Q1B and Q2A to close the second and third DC power switches Q1B and Q2A, and transmits PWM control signals to the fifth DC power switch Q3A to operate the fifth DC power switch Q3A in PWM mode to cause current to flow from the first side lead (L1 or Line 1), through the windings Wa from point B 328 to point A 326, and to the second side lead (L2 or Line 2) at a selected output voltage. In addition, current flows from the windings Wa through the second DC power switch Q1B and back to the first side lead L1. In this instance, the higher voltage is applied to point B 328 of the winding Wa, and the lower voltage is applied to point A 326 of the winding Wa to cause current to flow from point B 328 to point A 326 through the winding Wa.

In one example, such as in mode 2 when the voltage polarity sensor signal is high (e.g., has a value of 1) and the Hall effect sensor signal is low (e.g., has a value of 0), the motor controller 408 transmits control signals (e.g., low or 0 signals) to the first, third, fourth, sixth, and seventh DC power switches Q1A, Q2A, Q2B, Q3B to open the first, third, fourth, sixth, and seventh DC power switches Q1A, Q2A, Q2B, Q3B, and Q4A, transmits control signals (e.g., high or 1 signals) to the fifth and eighth DC power switches Q3A and Q4B to close the fifth and eighth DC power switches Q3A and Q4B, and transmits PWM control signals to the second DC power switch Q1B to operate the second DC power switch Q1B in PWM mode to cause current to flow from the second side lead (L2 or Line 2), through the windings Wa from point B 328 to point A 326, and to the first side lead (L1 or Line 1) at a selected output voltage. In addition, current flows from the windings Wa through the fifth DC power switch Q3A and back to the second side lead L2. In this instance, the higher voltage is applied to point B 328 of the winding Wa, and the lower voltage is applied to point A 326 of the winding Wa to cause current to flow from point B 328 to point A 326 through the winding Wa.

In another example, such as in mode 3 when the voltage polarity sensor signal is low (e.g., has a value of 0) and the Hall effect sensor signal is high (e.g., has a value of 1), the motor controller 408 transmits control signals (e.g., low or 0 signals) to the second, third, fifth, sixth, and eighth DC power switches Q1B, Q2A, Q3A, Q3B, and Q4B to open the second, third, fifth, sixth, and eighth DC power switches Q1B, Q2A, Q3A, Q3B, and Q4B, transmits control signals (e.g., high or 1 signals) to the first and fourth, DC power switches Q1A and Q2B to close the first and fourth, DC power switches Q1A and Q2B, and transmits PWM control signals to the seventh DC power switch Q4A to operate the seventh DC power switch Q4A in PWM mode to cause current to flow from the first side lead (L1 or Line 1), through the windings Wa from point A 326 to point B 328, and to the second side lead (L2 or Line 2) at a selected output voltage. In addition, current flows from the windings Wa through the fourth DC power switch Q2B and back to the first side lead L1. In this instance, the higher voltage is applied to point A 326 of the winding Wa, and the lower voltage is applied to point B 328 of the winding Wa to cause current to flow from point A 326 to point B 328 through the winding Wa.

In another example, such as in mode 4 when the voltage polarity sensor signal is high (e.g., has a value of 1) and the Hall effect sensor signal is high (e.g., has a value of 1), the motor controller 408 transmits control signals (e.g., low or 0 signals) to the first, second, third, fifth, and eighth DC power switches Q1A, Q1B, Q2A, Q3A, and Q4B to open the first, second, third, fifth, and eighth DC power switches Q1A, Q1B, Q2A, Q3A, and Q4B, transmits control signals (e.g., high or 1 signals) to the sixth and seventh DC power switches Q3B and Q4A to close sixth and seventh DC power switches Q3B and Q4A, and transmits PWM control signals to the fourth DC power switch Q2B to operate the fourth DC power switch Q2B in PWM mode to cause current to flow from the second side lead (L2 or Line 2), through the windings Wa from point A 326 to point B 328, and to the first side lead (L1 or Line 1) at a selected output voltage. In addition, current flows from the windings Wa through the seventh DC power switch Q4A and back to the second side lead L2. In this instance, the higher voltage is applied to point A 326 of the winding Wa, and the lower voltage is applied to point B 328 of the winding Wa to cause current to flow from point A 326 to point B 328 through the winding Wa.

In one example, the motor controller 408 includes a hardware processor with software executing one or more instructions stored on a non-transitory computer readable storage medium associated with the hardware processor. The non-transitory computer readable storage medium also may have data storage to store data, such as values of one or more sensor signals, values of line voltages, and/or other data. In this example, the processor processes the Hall effect sensor signal and the voltage polarity sensor signal and creates one or more driving logic control signals based on whether the Hall effect sensor signal is high or low and whether the voltage polarity sensor signal is high or low, and the motor controller 408 transmits the one or more driving logic control signals to the DC power switches Q1A, Q1B, Q2A, Q2B, Q3A, Q3B, Q4A, and Q4B (e.g., to the gates/gate drivers 308-322 of the DC power switches as described above) to open and/or close the DC power switches and/or operate the DC power switches in PWM mode. In one example, the motor controller 408 includes logic in which the Hall effect sensor signal and the voltage polarity sensor signal are XOR'd together to create one or more driving logic control signals based on whether the Hall effect sensor signal is high or low and whether the voltage polarity sensor signal is high or low, and the motor controller transmits the one or more driving logic control signals to the DC power switches Q1A, Q1B, Q2A, Q2B, Q3A, Q3B, Q4A, and Q4B (e.g., to the gates/gate drivers 308 322 of the DC power switches as described above) to open and/or dose the DC power switches and/or operate the DC power switches in PWM mode.

In another example, the motor controller 408 includes a digital signal processor (DSP), an application specific integrated circuit (ASIC), a field programmable gate array signal (FPGA) or other programmable logic device (PLD), discrete gate or transistor logic, discrete hardware components, or combinations thereof designed to perform the functions described herein. A hardware processor may be a microprocessor, commercially available processor, controller, microcontroller, or state machine. A processor may also be implemented as a combination of two or more computing components, e.g., a combination of a DSP and a microprocessor, a plurality of microprocessors, one or more microprocessors in conjunction with a DSP core, or any other such configuration.

### Startup and Off-Synchronous Operation

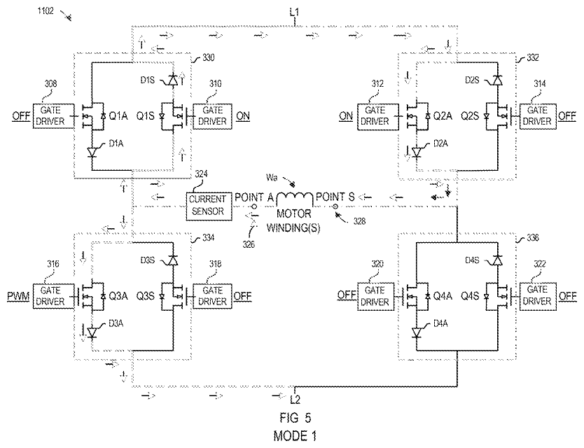

FIGS. 5-8 depict exemplary embodiments of four modes of operation that can be used for both startup and off-synchronous operation of the DC power switches Q1A, Q1B, Q2A, Q2B, Q3A, Q3B, Q4A, and Q4B. These modes will be referred to as mode 1, mode 2, mode 3, and mode 4.

FIG. 5 depicts an exemplary embodiment of mode 1. In this exemplary embodiment, the dot-dash lines show the location and direction in which current is always flowing in this mode. The long-dash lines show the location and direction of current flow when the PWM signal is high and causes the DC power switch receiving the PWM signal to be on. The dotted lines show the location and direction of current flow when the PWM signal is low and causes the DC power switch receiving the PWM signal to be off.

In mode 1, the DC power switches Q1A, Q1B, Q2A, Q2B, Q3A, Q3B, Q4A, and Q4B are arranged by the motor controller 408 to pass current from Line 1, through point B 328 to point A 326, and to Line 2. In mode 1, the motor controller 408 turns on the second DC power switch Q1B and the third DC power switch Q2A by transmitting an on or high signal to each of them and leaves them on while operating the fifth DC power switch Q3A in Pulse Width Modulated (PWM) mode by repeatedly transmitting on/high and off/low signals to the fifth DC power switch Q3A at a selected duty cycle and for a selected total period. The motor controller 408 turns the other DC power switches off by transmitting an off or low signal to each of them or leaves them off if already off. When the PWM signal is high and the fifth DC power switch Q3A is on, current is passed from Line 1, through the third DC power switch Q2A, through point B 328 to point A 326, and out to Line 2 by passing through the fifth DC power switch Q3A. When the PWM signal is low and the fifth DC power switch Q3A is off, the second DC power switch Q1B and the second diode D1B act as a freewheeling diode to allow current to continue circulating through the windings, thereby preventing any large inductive switching spikes.

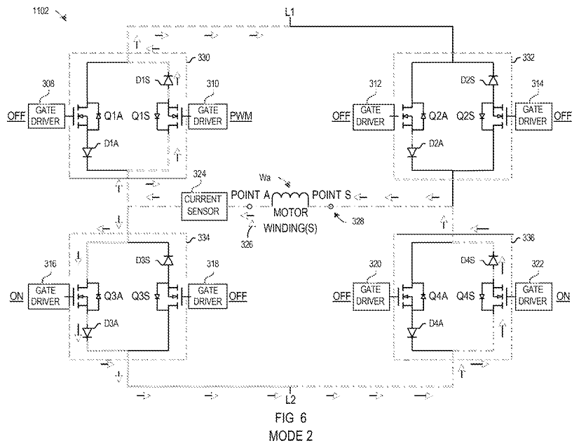

FIG. 6 depicts an exemplary embodiment of mode 2. In this exemplary embodiment, the dot-dash lines show the location and direction in which current is always flowing in this mode. The long-dash lines show the location and direction of current flow when the PWM signal is high and causes the DC power switch receiving the PWM signal to be on. The dotted lines show the location and direction of current flow when the PWM signal is low and causes the DC power switch receiving the PWM signal to be off.

In mode 2, the DC power switches Q1A, Q1B, Q2A, Q2B, Q3A, Q3B, Q4A, and Q4B are arranged to pass current from Line 2, through point B 328 to point A 326, and out to Line 1. In mode 2, the motor controller 408 turns on the eighth DC power switch Q4B and the fifth DC power switch Q3A by transmitting an on or high signal to each of them and leaves them on while operating the second DC power switch Q1B in PWM mode by repeatedly transmitting on/high and off/low signals to the second DC power switch Q1B at a selected duty cycle and for a selected total period. The motor controller 408 turns the other DC power switches off by transmitting an off or low signal to each of them or leaves them off if already off. When the PWM signal is high and the second DC power switch Q1B is on, current is passed from Line 2, through the eighth DC power switch Q4B, through point B 328 to point A 326, and out to Line 1 by passing through the second DC power switch Q1B. When the PWM signal is low and the second DC power switch Q1B is off, the fifth DC power switch Q3A and the fifth diode D3A act as a freewheeling diode to allow current to continue circulating through the windings, thereby preventing any large inductive switching spikes.

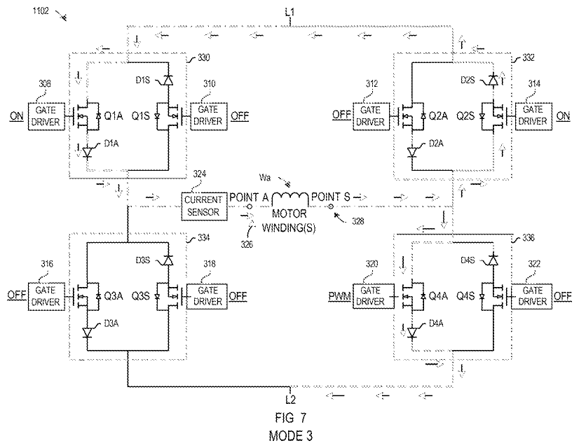

FIG. 7 depicts an exemplary embodiment of mode 3. In this exemplary embodiment, the dot-dash lines show the location and direction in which current is always flowing in this mode. The long-dash lines show the location and direction of current flow when the PWM signal is high and causes the DC power switch receiving the PWM signal to be on. The dotted lines show the location and direction of current flow when the PWM signal is low and causes the DC power switch receiving the PWM signal to be off.

In mode 3, the DC power switches Q1A, Q1B, Q2A, Q2B, Q3A, Q3B, Q4A, and Q4B are arranged to pass current from Line 1, through point A 326 to point B 328, and out to Line 2. In mode 3, the motor controller 408 turns on the first DC power switch Q1A and the fourth DC power switch Q2B by transmitting an on or high signal to each of them and leaves them on while operating the seventh DC power switch Q4A in PWM mode by repeatedly transmitting on/high and off/low signals to the seventh DC power switch Q4A at a selected duty cycle and for a selected total period. The motor controller 408 turns the other DC power switches off by transmitting an off or low signal to each of them or leaves them off if already off. When the PWM signal is high and the seventh DC power switch Q4A is on, current is passed from Line 1, through the first DC power switch Q1A, through point A 326 to point B 328, and out to Line 2 by passing through the seventh DC power switch Q4A. When the PWM signal is low and the seventh DC power switch Q4A is off, the fourth DC power switch Q2B and the fourth diode D2B act as a freewheeling diode to allow current to continue circulating through the windings, thereby preventing any large inductive switching spikes.

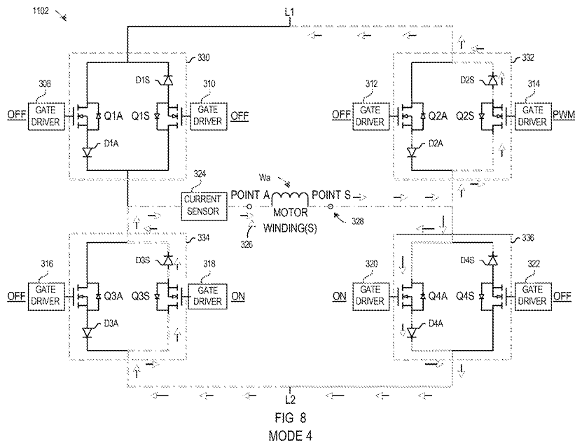

FIG. 8 depicts an exemplary embodiment of mode 4. In this exemplary embodiment, the dot-dash lines show the location and direction in which current is always flowing in this mode. The long-dash lines show the location and direction of current flow when the PWM signal is high and causes the DC power switch receiving the PWM signal to be on. The dotted lines show the location and direction of current flow when the PWM signal is low and causes the DC power switch receiving the PWM signal to be off.

In mode 4, the DC power switches Q1A, Q1B, Q2A, Q2B, Q3A, Q3B, Q4A, and Q4B are arranged to pass current from Line 2, through point A 326 to point B 328, and out to Line 1. In mode 4, the motor controller 408 turns on the sixth DC power switch Q3B and the seventh DC power switch Q4A by transmitting an on or high signal to each of them and leaves them on while operating the fourth DC power switch Q2B in PWM mode by repeatedly transmitting on/high and off/low signals to the fourth DC power switch Q2B at a selected duty cycle and for a selected total period. The motor controller 408 turns the other DC power switches off by transmitting an off or low signal to each of them or leaves them off if already off. When the PWM signal is high and the fourth DC power switch Q2B is on, current is passed from Line 2, through the sixth DC power switch Q3B, through point A 326 to point B 328, and out to Line 1 by passing through the fourth DC power switch Q2B. When the PWM signal is low and the fourth DC power switch Q2B is off, the seventh DC power switch Q4A and the seventh diode D4A act as a freewheeling diode to allow current to continue circulating through the windings, thereby preventing any large inductive switching spikes.

When the motor controller 408 is switching between the four modes, there is a path for current to continue to flow through the windings Wa without interruption. This prevents large inductive switching spikes.

### Motor Controller Switching Operations

When the motor controller 408 is operating the DC power switches Q1A, Q1B, Q2A, Q2B, Q3A, Q3B, Q4A, and Q4B in mode 1, current is flowing from Line 1, through point B 328 to point A 326, and out to Line 2. In mode 1, the voltage polarity sensor signal is low and the Hall effect sensor signal is low.

If the voltage polarity sensor signal changes to high and the Hall effect sensor signal remains low, the motor controller 408 switches the DC power switches Q1A, Q1B, Q2A, Q2B, Q3A, Q3B, Q4A, and Q4B on, off, and/or in PWM mode according to mode 2 to start drawing current from the Line 2 without changing the direction of the current in the windings Wb. In mode 1 at clock cycle (CC) 1, the second DC power switch Q1B and the third DC power switch Q2A are on with the PWM mode being operated on the fifth DC power switch Q3A. In the next clock cycle, the motor controller 408 turns the fifth DC power switch Q3A on fully. On the next clock cycle, the motor controller 408 turns the eighth DC power switch Q4B on. On the following clock cycle, the motor controller 408 turns the third DC power switch Q2A off and then operates the second DC power switch Q1B in PWM mode. At this point, the multispeed AC machine 302A is in mode 2 with the fifth DC power switch Q3A and the eighth DC power switch Q4B always on while operating the second DC power switch Q1B in PWM mode. The other DC power switches Q1A, Q2A, Q2B, Q3B, and Q4A are off. The motor controller 408 switching operations are shown in Table 1.

TABLE 1

| | Clock | Clock | Clock | Clock | Clock |
|---|---|---|---|---|---|
| | Cycle | Cycle | Cycle | Cycle | Cycle |
| Switch | 1 | 2 | 3 | 4 | 5 |
| Q1A | 0 | 0 | 0 | 0 | 0 |
| Q1B | 1 | 1 | 1 | 1 | PWM |
| Q2A | 1 | 1 | 1 | 0 | 0 |
| Q2B | 0 | 0 | 0 | 0 | 0 |
| Q3A | PWM | 1 | 1 | 1 | 1 |
| Q3B | 0 | 0 | 0 | 0 | 0 |
| Q4A | 0 | 0 | 0 | 0 | 0 |
| Q4B | 0 | 0 | 1 | 1 | 1 |

When the motor controller 408 is operating the DC power switches Q1A, Q1B, Q2A, Q2B, Q3A, Q3B, Q4A, and Q4B in mode 1, current is flowing from Line 1, through point B 328 to point A 326, and out to Line 2. In mode 1, the voltage polarity sensor signal is low and the Hall effect sensor signal is low.

If the voltage polarity sensor signal remains low and the Hall effect sensor signal changes to high, the motor controller 408 switches the DC power switches Q1A, Q1B, Q2A, Q2B, Q3A, Q3B, Q4A, and Q4B on, off, and/or in PWM mode according to mode 3 to change the direction of the current through the windings Wa while still drawing current from Line 1 to Line 2. At clock cycle 2, the motor controller 408 turns the PWM mode of the fifth DC power switch Q3A off while leaving the second DC power switch Q1B and the third DC power switch Q2A on. On the next clock cycle, the motor controller 408 turns the eighth DC power switch Q4B on. On the following clock cycle, the motor controller 408 turns the third DC power switch Q2A off. After turning the third DC power switch Q2A off, two clock cycles of dead time (DT) optionally are inserted by the motor controller 408 to allow enough time for the third DC power switch Q2A to be fully turned off before the motor controller 408 turns the seventh DC power switch Q4A on to prevent any shoot through. After the dead time, the motor controller 408 turns the first DC power switch Q1A on. After that, the motor controller 408 turns the seventh DC power switch Q4A on. At this point, the first DC power switch Q1A, the second DC power switch Q1B, the seventh DC power switch Q4A, and the eighth DC power switch Q4B are all on applying the high voltage that was being applied to point B 328 to point A 326 with bi directional switches Q1 330 and Q4 336. Changing the side of the coils the high voltage is applied to with bi-directional switches allows the current to continue flowing the way it was until the new voltage difference drives that current back the other direction. Once the current has changed directions (I CH (change)) and is flowing from Line 1, through point A 326 to point B 328, and back out to Line 2, the motor controller 408 continues the switching process.

The motor controller 408 then turns the eighth DC power switch Q4B off and turns the second DC power switch Q1B off on the following clock cycle. Two more clock cycles of dead time (DT) optionally are inserted at this point by the motor controller 408 before the motor controller turns the fourth DC power switch Q2B on to ensure that the eighth DC power switch Q4B is fully off, preventing shoot through between the fourth DC power switch Q2B and the eighth DC power switch Q4B. After the dead time, the motor controller 408 turns the fourth DC power switch Q2B on and then operates the seventh DC power switch Q4A in PWM mode. At this point, the multispeed AC machine 302A is in mode 3 with the first DC power switch Q1A and the fourth DC power switch Q2B fully on and the seventh DC power switch Q4A in PWM mode. The motor controller 408 switching operations are shown in Table 2.

TABLE 2

| | CC | CC | CC | CC | CC | CC | CC | CC | CC | CC | CC | CC | CC | CC | CC |
|---|---|---|---|---|---|---|---|---|---|---|---|---|---|---|---|
| Switch | 1 | 2 | 3 | 4 | 5 | 6 | 7 | 8 | 9 | 19 | 11 | 12 | 13 | 14 | 15 |
| Q1A | 0 | 0 | 0 | 0 | DT | DT | 1 | 1 | I CH | 1 | 1 | DT | DT | 1 | 1 |
| Q1B | 1 | 1 | 1 | 1 | DT | DT | 1 | 1 | I CH | 1 | 0 | DT | DT | 0 | 0 |
| Q2A | 1 | 1 | 1 | 0 | DT | DT | 0 | 0 | I CH | 0 | 0 | DT | DT | 0 | 0 |
| Q2B | 0 | 0 | 0 | 0 | DT | DT | 0 | 0 | I CH | 0 | 0 | DT | DT | 1 | 1 |
| Q3A | PWM | 0 | 0 | 0 | DT | DT | 0 | 0 | I CH | 0 | 0 | DT | DT | 0 | 0 |
| Q3B | 0 | 0 | 0 | 0 | DT | DT | 0 | 0 | I CH | 0 | 0 | DT | DT | 0 | 0 |
| Q4A | 0 | 0 | 0 | 0 | DT | DT | 0 | 1 | I CH | 1 | 1 | DT | DT | 1 | PWM |
| Q4B | 0 | 0 | 1 | 1 | DT | DT | 1 | 1 | I CH | 0 | 0 | DT | DT | 0 | 0 |

When the motor controller 408 is operating the DC power switches Q1A, Q1B, Q2A, Q2B, Q3A, Q3B, Q4A, and Q4B in mode 1, current is flowing from Line 1, through point B 328 to point A 326, and out to Line 2. In mode 1, the voltage polarity sensor signal is low and the Hall effect sensor signal is low.

If the voltage polarity sensor signal changes to high and the Hall effect sensor signal changes to high, the motor controller 408 switches the DC power switches Q1A, Q1B, Q2A, Q2B, Q3A, Q3B, Q4A, and Q4B on, off, and/or in PWM mode according to mode 4 to change the direction of the current through the windings while also beginning to draw current from Line 2 instead of Line 1. At clock cycle 2, the motor controller 408 stops running the fifth DC power switch Q3A in PWM mode and turns it on. On the next clock cycle, the motor controller 408 turns the second DC power switch Q1B off. The motor controller 408 optionally inserts two clock cycles of dead time (DT) before the motor controller turns on the sixth DC power switch Q3B to prevent shoot through from happening between switching the second DC power switch Q1B and the sixth DC power switch Q3B. Following the dead time, the motor controller 408 turns the fourth DC power switch Q2B on. On the next clock cycle, the motor controller 408 turns the sixth DC power switch Q3B on. At this point, the third DC power switch Q2A, the fourth DC power switch Q2B, the fifth DC power switch Q3A, and the sixth DC power switch Q3B are all on applying the higher voltage that was being applied from Line 1 to point B 328 to point A 326 coming from Line 2 with bi-directional switches Q2 332 and Q3 334. This configuration will begin to drive the current through the windings Wa in the opposite direction (I CH (change)) while also sending the current to the opposite line.

Once the current has begun flowing from Line 2 through point A 326 to point B 328 and out to Line 1, the motor controller 408 continues the switching process. First, the motor controller 408 turns the third DC power switch Q2A off and then turns the fifth DC power switch Q3A off. Two clock cycles of dead time (DT) optionally are inserted by the motor controller 408 before the motor controller turns the seventh DC power switch Q4A on to ensure the third DC power switch Q2A is fully off to prevent shoot through from happening between the third DC power switch Q2A and the seventh DC power switch Q4A. After the dead time, the motor controller 408 turns the seventh DC power switch Q4A on and then operates the fourth DC power switch Q2B in PWM mode. At this point, the multispeed AC machine 302A is in mode 4 with the sixth DC power switch Q3B and the seventh DC power switch Q4A always on with the fourth DC power switch Q2B operating in PWM mode. The motor controller 408 switching operations are shown in Table 3.

TABLE 3

| | CC | CC | CC | CC | CC | CC | CC | CC | CC | CC | CC | CC | CC | CC |
|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 |
| Q1A | 0 | 0 | 0 | DT | DT | 0 | 0 | I CH | 0 | 0 | DT | DT | 0 | 0 |
| Q1B | 1 | 1 | 0 | DT | DT | 0 | 0 | I CH | 0 | 0 | DT | DT | 0 | 0 |
| Q2A | 1 | 1 | 1 | DT | DT | 1 | 1 | I CH | 0 | 0 | DT | DT | 0 | 0 |
| Q2B | 0 | 0 | 0 | DT | DT | 1 | 1 | I CH | 1 | 1 | DT | DT | 1 | PWM |
| Q3A | PWM | 1 | 1 | DT | DT | 1 | 1 | I CH | 1 | 0 | DT | DT | 0 | 0 |
| Q3B | 0 | 0 | 0 | DT | DT | 0 | 1 | I CH | 1 | 1 | DT | DT | 1 | 1 |
| Q4A | 0 | 0 | 0 | DT | DT | 0 | 0 | I CH | 0 | 0 | DT | DT | 1 | 1 |
| Q4B | 0 | 0 | 0 | DT | DT | 0 | 0 | I CH | 0 | 0 | DT | DT | 0 | 0 |

When the motor controller 408 is operating the DC power switches Q1A, Q1B, Q2A, Q2B, Q3A, Q3B, Q4A, and Q4B in mode 2, current is flowing from Line 2, through point B 328 to point A 326, and out to Line 1. In mode 2, the voltage polarity sensor signal is high and the Hall effect sensor signal is low.

If the voltage polarity sensor signal changes to low and the Hall effect sensor signal changes to high, the motor controller 408 switches the DC power switches Q1A, Q1B, Q2A, Q2B, Q3A, Q3B, Q4A, and Q4B on, off, and/or in PWM mode according to mode 3 to change the direction of the current through the windings Wb while also beginning to draw current from Line 1 instead of Line 2. In the second clock cycle, the motor controller 408 stops operating the second DC power switch Q1B in PWM mode and turns it on. On the next clock cycle, the motor controller 408 turns the fifth DC power switch Q3A off. Two clock cycles of dead time (DT) optionally are inserted by the motor controller 408 before the motor controller turns on the first DC power switch Q1A to prevent shoot through between the first DC power switch Q1A and the fifth DC power switch Q3A. Following the optional dead time, the motor controller 408 turns the seventh DC power switch Q4A on. On the next clock cycle, the motor controller 408 turns the first DC power switch Q1A on. At this point, the first DC power switch Q1A, the second DC power switch Q1B, the seventh DC power switch Q4A, and the eighth DC power switch Q4B are all on applying the higher voltage that was being applied from Line 2 to point B 328 to point A 326 coming from Line 1 with the bi-directional switches Q1 330 and Q4 336. This configuration will begin to drive the current through the windings Wa in the opposite direction (I CH (change)) while also sending the current to the opposite line.

Once the current has begun flowing from Line 1, through point A 326 to point B 328, and out to Line 2, the motor controller 408 continues the switching process. First, the motor controller 408 turns the eighth DC power switch Q4B off and then turns the second DC power switch Q1B off. Two clock cycles of dead time (DT) optionally are inserted by the motor controller 408 to make sure the eighth DC power switch Q4B is fully off before the motor controller turns the fourth DC power switch Q2B on to prevent shoot through between the fourth DC power switch Q2B and the eighth DC power switch Q4B. After the dead time, the motor controller 408 turns the fourth DC power switch Q2B on and then operates the seventh DC power switch Q4A in PWM mode. At this point, the multispeed AC machine 302A is in mode 3 with the first DC power switch Q1A and the fourth DC power switch Q2B always on and the seventh DC power switch Q4A in PWM mode. The motor controller 408 switching operations are shown in Table 4.

TABLE 4

| | CC | CC | CC | CC | CC | CC | CC | CC | CC | CC | CC | CC | CC | CC |
|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 |
| Q1A | 0 | 0 | 0 | DT | DT | 0 | 1 | I CH | 1 | 1 | DT | DT | 1 | 1 |
| Q1B | PWM | 1 | 1 | DT | DT | 1 | 1 | I CH | 1 | 0 | DT | DT | 0 | 0 |
| Q2A | 0 | 0 | 0 | DT | DT | 0 | 0 | I CH | 0 | 0 | DT | DT | 0 | 0 |
| Q2B | 0 | 0 | 0 | DT | DT | 0 | 0 | I CH | 0 | 0 | DT | DT | 1 | 1 |
| Q3A | 1 | 1 | 0 | DT | DT | 0 | 0 | I CH | 0 | 0 | DT | DT | 0 | 0 |
| Q3B | 0 | 0 | 0 | DT | DT | 0 | 0 | I CH | 0 | 0 | DT | DT | 0 | 0 |
| Q4A | 0 | 0 | 0 | DT | DT | 1 | 1 | I CH | 1 | 1 | DT | DT | 1 | PWM |
| Q4B | 1 | 1 | 1 | DT | DT | 1 | 1 | I CH | 0 | 0 | DT | DT | 0 | 0 |

When the motor controller 408 is operating the DC power switches Q1A, Q1B, Q2A, Q2B, Q3A, Q3B, Q4A, and Q4B in mode 2, current is flowing from Line 2, through point B 328 to point A 326, and out to Line 1. In mode 2, the voltage polarity sensor signal is high and the Hall effect sensor signal is low.

If the Hall effect sensor signal changes, resulting in the voltage polarity sensor signal being high and the Hall effect sensor signal being high, the motor controller 408 switches the DC power switches Q1A, Q1B, Q2A, Q2B, Q3A, Q3B, Q4A, and Q4B on, off, and/or in PWM mode according to mode 4 to change the direction of current through the windings Wb while still drawing current from Line 2 to Line 1. In the second clock cycle, the motor controller 408 stops operating the second DC power switch Q1B in PWM mode and turns the second DC power switch Q1B off. On the next clock cycle, the motor controller 408 turns the third DC power switch Q2A on and then turns the eighth DC power switch Q4B off. Two clock cycles of dead time (DT) optionally are inserted by the motor controller to make sure the eighth DC power switch Q4B is fully off before the motor controller turns the fourth DC power switch Q2B on to prevent shoot through between the fourth DC power switch Q2B and the eighth DC power switch Q4B. Following the dead time, the motor controller 408 turns the sixth DC power switch Q3B on and then turns the fourth DC power switch Q2B on. At this point, the third DC power switch Q2A, the fourth DC power switch Q2B, the fifth DC power switch Q3A, and the sixth DC power switch Q3B are all on applying the high voltage that was being applied to point B 328 to point A 326 with bi-directional switches Q2 332 and Q3 334. Changing the side of the coils the high voltage is applied to with the bi-directional switches Q2 332 and Q3 334 allows the current to continue flowing the way it was until the new voltage difference drives that current back the other direction (I CH).

Once the current has started flowing from point A 326 to point B 328, the motor controller 408 continues the switching process. First, the motor controller 408 turns the third DC power switch Q2A off and then turns the fifth DC power switch Q3A off. Two clock cycles of dead time (DT) optionally are inserted by the motor controller 408 to make sure the third DC power switch Q2A is fully off before the motor controller turns the seventh DC power switch Q4A on to prevent shoot through between the third DC power switch Q2A and the seventh DC power switch Q4A. Following the dead time, the motor controller 408 turns the seventh DC power switch Q4A on and then operates the fourth DC power switch Q2B in PWM mode. At this point, the multispeed AC machine 302A is in mode 4 with the sixth DC power switch Q3B and the seventh DC power switch Q4A always on while operating the fourth DC power switch Q2B in PWM mode. The motor controller 408 switching operations are shown in Table 5.

TABLE 5

| | CC | CC | CC | CC | CC | CC | CC | CC | CC | CC | CC | CC | CC | CC | CC |
|---|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 | 15 |
| Q1A | 0 | 0 | 0 | 0 | DT | DT | 0 | 0 | I CH | 0 | 0 | DT | DT | 0 | 0 |
| Q1B | PWM | 0 | 0 | 0 | DT | DT | 0 | 0 | I CH | 0 | 0 | DT | DT | 0 | 0 |
| Q2A | 0 | 0 | 1 | 1 | DT | DT | 1 | 1 | I CH | 0 | 0 | DT | DT | 0 | 0 |
| Q2B | 0 | 0 | 0 | 0 | DT | DT | 0 | 1 | I CH | 1 | 1 | DT | DT | 1 | PWM |
| Q3A | 1 | 1 | 1 | 1 | DT | DT | 1 | 1 | I CH | 1 | 0 | DT | DT | 0 | 0 |
| Q3B | 0 | 0 | 0 | 0 | DT | DT | 1 | 1 | I CH | 1 | 1 | DT | DT | 1 | 1 |
| Q4A | 0 | 0 | 0 | 0 | DT | DT | 0 | 0 | I CH | 0 | 0 | DT | DT | 1 | 1 |
| Q4B | 1 | 1 | 1 | 0 | DT | DT | 0 | 0 | I CH | 0 | 0 | DT | DT | 0 | 0 |

When the motor controller 408 is operating the DC power switches Q1A, Q1B, Q2A, Q2B, Q3A, Q3B, Q4A, and Q4B in mode 2, current is flowing from Line 2, through point B 328 to point A 326, and out to Line 1. In mode 2, the voltage polarity sensor signal is high and the Hall effect sensor signal is low.

If the voltage polarity sensor signal changes to low, resulting in the voltage polarity sensor signal being low and the Hall effect sensor signal being low, the motor controller 408 switches the DC power switches Q1A, Q1B, Q2A, Q2B, Q3A, Q3B, Q4A, and Q4B on, off, and/or in PWM mode according to mode 1 to start drawing current from the Line 1 without changing the direction of the current in the windings Wa.

In the second clock cycle, the motor controller 408 stops operating the second DC power switch Q1B in PWM mode and turns it on. Next, the motor controller 408 turns the third DC power switch Q2A on and then turns the eighth DC power switch Q4B off. The motor controller 408 operates the fifth DC power switch Q3A in PWM mode. At this point, the multispeed AC machine 302A is in mode 1 with the second DC power switch Q1B and the third DC power switch Q2A always on while operating the fifth DC power switch Q3A in PWM mode. The motor controller 408 switching operations are shown in Table 6.

TABLE 6

| | CC | CC | CC | CC | CC |
|---|---|---|---|---|---|
| Switch | 1 | 2 | 3 | 4 | 5 |
| Q1A | 0 | 0 | 0 | 0 | 0 |
| Q1B | PWM | 1 | 1 | 1 | 1 |
| Q2A | 0 | 0 | 1 | 1 | 1 |
| Q2B | 0 | 0 | 0 | 0 | 0 |
| Q3A | 1 | 1 | 1 | 1 | PWM |
| Q3B | 0 | 0 | 0 | 0 | 0 |
| Q4A | 0 | 0 | 0 | 0 | 0 |
| Q4B | 1 | 1 | 1 | 0 | 0 |

When the motor controller 408 is operating the DC power switches Q1A, Q1B, Q2A, Q2B, Q3A, Q3B, Q4A, and Q4B in mode 3, current is flowing from Line 1, through point A 326 to point B 328, and out to Line 2. In mode 3, the voltage polarity sensor signal is low and the Hall effect sensor signal is high.

If the voltage polarity sensor signal changes, resulting in the voltage polarity sensor signal being high and the Hall effect sensor signal being high, the motor controller 408 switches the DC power switches Q1A, Q1B, Q2A, Q2B, Q3A, Q3B, Q4A, and Q4B on, off, and/or in PWM mode according to mode 4 to start drawing current from Line 2 without changing the direction of current in the windings Wa. In the second clock cycle, the motor controller 408 stops operating the seventh DC power switch Q4A in PWM mode and turns it on. Next, the motor controller 408 turns the sixth DC power switch Q3B on and then turns the first DC power switch Q1A off. The motor controller 408 operates the fourth DC power switch Q2B in PWM mode. At this point, the multispeed AC machine 302A is in mode 4 with the sixth DC power switch Q3B and the seventh DC power switch Q4A always on while operating the fourth DC power switch Q2B in PWM mode. The motor controller 408 switching operations are shown in Table 7.

TABLE 7

| | CC | CC | CC | CC | CC |
|---|---|---|---|---|---|
| Switch | 1 | 2 | 3 | 4 | 5 |
| Q1A | 1 | 1 | 1 | 0 | 0 |
| Q1B | 0 | 0 | 0 | 0 | 0 |
| Q2A | 0 | 0 | 0 | 0 | 0 |
| Q2B | 1 | 1 | 1 | 1 | PWM |
| Q3A | 0 | 0 | 0 | 0 | 0 |
| Q3B | 0 | 0 | 1 | 1 | 1 |
| Q4A | PWM | 1 | 1 | 1 | 1 |
| Q4B | 0 | 0 | 0 | 0 | 0 |

When the motor controller 408 is operating the DC power switches Q1A, Q1B, Q2A, Q2B, Q3A, Q3B, Q4A, and Q4B in mode 3, current is flowing from Line 1, through point A 326 to point B 328, and out to Line 2. In mode 3, the voltage polarity sensor signal is low and the Hall effect sensor signal is high.

If the Hall effect sensor signal changes, resulting in the voltage polarity sensor signal being low and the Hall effect sensor signal being low, the motor controller 408 switches the DC power switches Q1A, Q1B, Q2A, Q2B, Q3A, Q3B, Q4A, and Q4B on, off, and/or in PWM mode according to mode 1 to change the direction of current through the windings Wa while still drawing current from Line 1 to Line 2.

In the second clock cycle, the motor controller 408 stops operating the seventh DC power switch Q4A in PWM mode and turns it off. Next, the motor controller 408 turns the sixth DC power switch Q3B on and then turns the first DC power switch Q1A off. Two clock cycles of dead time (DT) optionally are inserted by the motor controller 408 to make sure the first DC power switch Q1A is fully off before the motor controller turns the fifth DC power switch Q3A on to prevent shoot through between the first DC power switch Q1A and the fifth DC power switch Q3A. Following the dead time, the motor controller 408 turns the third DC power switch Q2A on and then turns the fifth DC power switch Q3A on. At this point, the third DC power switch Q2A, the fourth DC power switch Q2B, the fifth DC power switch Q3A, and the sixth DC power switch Q3B are all on applying the high voltage that was being applied to point A 326 to point B 328 with bi-directional switches Q2 332 and Q3 334. Changing the side of the coils the high voltage is applied to with bi-directional switches Q2 332 and Q3 334 allows the current to continue flowing the way it was until the new voltage difference drives that current back the other direction (I CH).

Once the current has started flowing from point B 328 to point A 326, the motor controller 408 continues the switching process. First, the motor controller 408 turns the sixth DC power switch Q3B off and then turns the fourth DC power switch Q2B off. Two clock cycles of dead time (DT) optionally are inserted by the motor controller 408 to make sure the sixth DC power switch Q3B is fully off before the motor controller turns the second DC power switch Q1B on to prevent shoot through between the second DC power switch Q1B and the sixth DC power switch Q3B. After the dead time, the motor controller 408 turns the second DC power switch Q1B on, and the motor controller operates the fifth DC power switch Q3A in PWM mode. At this point, the multispeed AC machine 302A is in mode 1 with the second DC power switch Q1B and the third DC power switch Q2A always on while the motor controller 408 is operating the fifth DC power switch Q3A in PWM mode. The motor controller 408 switching operations are shown in Table 8.

TABLE 8

| | CC | CC | CC | CC | CC | CC | CC | CC | CC | CC | CC | CC | CC | CC | CC |
|---|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 | 15 |
| Q1A | 1 | 1 | 1 | 0 | DT | DT | 0 | 0 | I CH | 0 | 0 | DT | DT | 0 | 0 |
| Q1B | 0 | 0 | 0 | 0 | DT | DT | 0 | 0 | I CH | 0 | 0 | DT | DT | 1 | 1 |
| Q2A | 0 | 0 | 0 | 0 | DT | DT | 1 | 1 | I CH | 1 | 1 | DT | DT | 1 | 1 |
| Q2B | 1 | 1 | 1 | 1 | DT | DT | 1 | 1 | I CH | 1 | 0 | DT | DT | 0 | 0 |
| Q3A | 0 | 0 | 0 | 0 | DT | DT | 0 | 1 | I CH | 1 | 1 | DT | DT | 1 | PWM |
| Q3B | 0 | 0 | 1 | 1 | DT | DT | 1 | 1 | I CH | 0 | 0 | DT | DT | 0 | 0 |
| Q4A | PWM | 0 | 0 | 0 | DT | DT | 0 | 0 | 1 CH | 0 | 0 | DT | DT | 0 | 0 |
| Q4B | 0 | 0 | 0 | 0 | DT | DT | 0 | 0 | I CH | 0 | 0 | DT | DT | 0 | 0 |

When the motor controller 408 is operating the DC power switches Q1A, Q1B, Q2A, Q2B, Q3A, Q3B, Q4A, and Q4B in mode 3, current is flowing from Line 1, through point A 326 to point B 328, and out to Line 2. In mode 3, the voltage polarity sensor signal is low and the Hall effect sensor signal is high.

If the voltage polarity sensor signal changes and the Hall effect sensor signal changes, resulting in the voltage polarity sensor signal being high and the Hall effect sensor signal being low, the motor controller 408 switches the DC power switches Q1A, Q1B, Q2A, Q2B, Q3A, Q3B, Q4A, and Q4B on, off, and/or in PWM mode according to mode 2 to change the direction of the current through the windings Wa while also beginning to draw current from Line 2 instead of Line 1.

In the second clock cycle, the motor controller 408 stops operating the seventh DC power switch Q4A in PWM mode and turns it on. On the next clock cycle, the motor controller 408 turns the fourth DC power switch Q2B off. Two clock cycles of dead time (DT) optionally are inserted by the motor controller 408 to make sure the fourth DC power switch Q2B is fully off before the motor controller turns the eighth DC power switch Q4B on to prevent shoot through between the fourth DC power switch Q2B and the eighth DC power switch Q4B. After the dead time, the motor controller 408 turns the second DC power switch Q1B on and then turns the eighth DC power switch Q4B on. At this point, the first DC power switch Q1A, the second DC power switch Q1B, the seventh DC power switch Q4A, and the eighth DC power switch Q4B are all on applying the higher voltage that was being applied from Line 2 to point A 326 to point B 328 coming from Line 2 with bi-directional switches Q1 330 and Q4 336. This will begin to drive the current through the windings Wa in the opposite direction (I CH) while also sending it to the opposite line.

Once the current has begun flowing from Line 2, through point B 328 to point A 326, and out to Line 1, the motor controller 408 continues the switching process. First, the motor controller 408 turns the first DC power switch Q1A off and then turns the seventh DC power switch Q4A off. Two clock cycles of dead time (DT) optionally are inserted by the motor controller 408 to make sure the first DC power switch Q1A is fully off before the motor controller turns the fifth DC power switch Q3A on to prevent shoot through between the first DC power switch Q1A and the fifth DC power switch Q3A. After the dead time, the motor controller 408 turns the fifth DC power switch Q3A on and operates the second DC power switch Q1B in PWM mode. At this point, the multispeed AC machine 302A is in mode 2 with the fifth DC power switch Q3A and the eighth DC power switch Q4B always on while operating the second DC power switch Q1B in PWM mode. The motor controller 408 switching operations are shown in Table 9.

TABLE 9

| | CC | CC | CC | CC | CC | CC | CC | CC | CC | CC | CC | CC | CC | CC |
|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 |
| Q1A | 1 | 1 | 1 | DT | DT | 1 | 1 | 1 CH | 0 | 0 | DT | DT | 0 | 0 |
| Q1B | 0 | 0 | 0 | DT | DT | 1 | 1 | I CH | 1 | 1 | DT | DT | 1 | PWM |
| Q2A | 0 | 0 | 0 | DT | DT | 0 | 0 | I CH | 0 | 0 | DT | DT | 0 | 0 |
| Q2B | 1 | 1 | 0 | DT | DT | 0 | 0 | I CH | 0 | 0 | DT | DT | 0 | 0 |
| Q3A | 0 | 0 | 0 | DT | DT | 0 | 0 | 1 CH | 0 | 0 | DT | DT | 1 | 1 |
| Q3B | 0 | 0 | 0 | DT | DT | 0 | 0 | 1 CH | 0 | 0 | DT | DT | 0 | 0 |
| Q4A | PWM | 1 | 1 | DT | DT | 1 | 1 | 1 CH | 1 | 0 | DT | DT | 0 | 0 |
| Q4B | 0 | 0 | 0 | DT | DT | 0 | 1 | 1 CH | 1 | 1 | DT | DT | 1 | 1 |

When the motor controller 408 is operating the DC power switches Q1A, Q1B, Q2A, Q2B, Q3A, Q3B, Q4A, and Q4B in mode 4, current flowing from Line 1, through point A 326 to point B 328, and out to Line 2. In mode 4, the voltage polarity sensor signal is high and the Hall effect sensor signal is high.

If the voltage polarity sensor signal changes and the Hall effect sensor signal changes, resulting in the voltage polarity sensor signal being low and the Hall effect sensor signal being low, the motor controller 408 switches the DC power switches Q1A, Q1B, Q2A, Q2B, Q3A, Q3B, Q4A, and Q4B on, off, and/or in PWM mode according to mode 1 to change the direction of the current through the windings Wb while also beginning to draw current from Line 2 instead of Line 1

On the second clock cycle, the motor controller 408 stops operating the fourth DC power switch Q2B in PWM mode and turns it on. Then, the motor controller 408 turns the seventh DC power switch Q4A off. Two clock cycles of dead time (DT) optionally are inserted by the motor controller 408 to ensure the seventh DC power switch Q4A is fully off before the motor controller turns the third DC power switch Q2A on to prevent shoot through between the third DC power switch Q2A and the seventh DC power switch Q4A. After the dead time, the motor controller 408 turns the fifth DC power switch Q3A on and then turns the third DC power switch Q2A on. At this point, the third DC power switch Q2A, the fourth DC power switch Q2B, the fifth DC power switch Q3A, and the sixth DC power switch Q3B are all on applying the higher voltage that was being applied from Line 1 to point A 326 to point B 328 coming from Line 2 with bi-directional switches Q2 332 and Q3 334. This will begin to drive the current through the windings Wa in the opposite direction (I CH) while also sending it to the opposite line.

Once the current has begun flowing from Line 2, through point B 328 to point A 326, and out to Line 1, the motor controller 408 continues the switching process. The motor controller 408 turns the sixth DC power switch Q3B off and then turns the fourth DC power switch Q2B off. Two clock cycles of dead time (DT) optionally are inserted by the motor controller 408 to ensure that the sixth DC power switch Q3B is fully off before the motor controller turns the second DC power switch Q1B on to prevent shoot through between the second DC power switch Q1B and the sixth DC power switch Q3B. After the dead time, the motor controller 408 turns the second DC power switch Q1B on the and operates the fifth DC power switch Q3A in PWM mode. At this point, the multispeed AC machine 302A is in mode 1 with the second DC power switch Q1B and the third DC power switch Q2A always on while the motor controller 408 is operating the fifth DC power switch Q3A in PWM mode. The motor controller 408 switching operations are shown in Table 10.

TABLE 10

| | CC | CC | CC | CC | CC | CC | CC | CC | CC | CC | CC | CC | CC | CC |
|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 |
| Q1A | 0 | 0 | 0 | DT | DT | 0 | 0 | I CH | 0 | 0 | DT | DT | 0 | 0 |
| Q1B | 0 | 0 | 0 | DT | DT | 0 | 0 | I CH | 0 | 0 | DT | DT | 1 | 1 |
| Q2A | 0 | 0 | 0 | DT | DT | 0 | 1 | I CH | 1 | 1 | DT | DT | 1 | 1 |
| Q2B | PWM | 1 | 1 | DT | DT | 1 | 1 | I CH | 1 | 0 | DT | DT | 0 | 0 |
| Q3A | 0 | 0 | 0 | DT | DT | 1 | 1 | I CH | 1 | 1 | DT | DT | 1 | PWM |
| Q3B | 1 | 1 | 1 | DT | DT | 1 | 1 | I CH | 0 | 0 | DT | DT | 0 | 0 |
| Q4A | 1 | 1 | 0 | DT | DT | 0 | 0 | I CH | 0 | 0 | DT | DT | 0 | 0 |
| Q4B | 0 | 0 | 0 | DT | DT | 0 | 0 | I CH | 0 | 0 | DT | DT | 0 | 0 |

When the motor controller 408 is operating the DC power switches Q1A, Q1B, Q2A, Q2B, Q3A, Q3B, Q4A, and Q4B in mode 4, current flowing from Line 1, through point A 326 to point B 328, and out to Line 2. In mode 4, the voltage polarity sensor signal is high and the Hall effect sensor signal is high.

If the Hall effect sensor signal changes, resulting in the voltage polarity sensor signal being high and the Hall effect sensor signal being low, the motor controller 408 switches the DC power switches Q1A, Q1B, Q2A, Q2B, Q3A, Q3B, Q4A, and Q4B on, off, and/or in PWM mode according to mode 2 to change the direction of current through the windings Wa while still drawing current from Line 1 to Line 2.

In the second clock cycle, the motor controller 408 stops operating the fourth DC power switch Q2B in PWM mode and turns it off. Next, the motor controller 408 turns the first DC power switch Q1A on and then turns the sixth DC power switch Q3B off. Two clock cycles of dead time optionally are inserted by the motor controller 408 to ensure that the sixth DC power switch Q3B is fully off to prevent shoot through between the second DC power switch Q1B and the sixth DC power switch Q3B. After the dead time, the motor controller 408 turns the eighth DC power switch Q4B on and then turns the second DC power switch Q1B on. At this point, the first DC power switch Q1A, the second DC power switch Q1B, the seventh DC power switch Q4A, and the eighth DC power switch Q4B are all on applying the higher voltage that was being applied from Line 1 to point A 326 to point B 328 with bi-directional switches Q1 330 and Q4 336. Changing the side of the coils the high voltage is applied to with bi directional switches Q1 330 and Q4 336 allows the current to continue flowing the way it was until the new voltage difference drives that current back the other direction (I CH).

Once the current has started flowing from point B 328 to point A 326, the motor controller 408 continues the switching process. First, the motor controller 408 turns the first DC power switch Q1A off and then turns the seventh DC power switch Q4A off. Two clock cycles of dead time (DT) optionally are inserted by the motor controller 408 to make sure the first DC power switch Q1A is fully off before the motor controller turns the fifth DC power switch Q3A on to prevent shoot through between the first DC power switch Q1A and the fifth DC power switch Q3A. After the dead time, the motor controller 408 turns the fifth DC power switch Q3A on and operates the second DC power switch Q1B in PWM mode. At this point, the multispeed AC machine 302A is in mode 2 with the fifth DC power switch Q3A and the eighth DC power switch Q4B always on while the second DC power switch Q1B is operated in PWM mode. The motor controller 408 switching operations are shown in Table 11.

TABLE 11

| | CC | CC | CC | CC | CC | CC | CC | CC | CC | CC | CC | CC | CC | CC | CC |
|---|---|---|---|---|---|---|---|---|---|---|---|---|---|---|---|
| Switch | 1 | 2 | 3 | 4 | 5 | 6 | 7 | 8 | 9 | 10 | 11 | 12 | 13 | 14 | 15 |
| Q1A | 0 | 0 | 1 | 1 | DT | DT | 1 | 1 | I CH | 0 | 0 | DT | DT | 0 | 0 |
| Q1B | 0 | 0 | 0 | 0 | DT | DT | 0 | 1 | I CH | 1 | 1 | DT | DT | 1 | PWM |
| Q2A | 0 | 0 | 0 | 0 | DT | DT | 0 | 0 | I CH | 0 | 0 | DT | DT | 0 | 0 |
| Q2B | PWM | 0 | 0 | 0 | DT | DT | 0 | 0 | I CH | 0 | 0 | DT | DT | 0 | 0 |
| Q3A | 0 | 0 | 0 | 0 | DT | DT | 0 | 0 | I CH | 0 | 0 | DT | DT | 1 | 1 |
| Q3B | 1 | 1 | 1 | 0 | DT | DT | 0 | 0 | I CH | 0 | 0 | DT | DT | 0 | 0 |
| Q4A | 1 | 1 | 1 | 1 | DT | DT | 1 | 1 | I CH | 1 | 0 | DT | DT | 0 | 0 |
| Q4B | 0 | 0 | 0 | 0 | DT | DT | 1 | 1 | I CH | 1 | 1 | DT | DT | 1 | 1 |

When the motor controller 408 is operating the DC power switches Q1A, Q1B, Q2A, Q2B, Q3A, Q3B, Q4A, and Q4B in mode 4, current flowing from Line 1, through point A 326 to point B 328, and out to Line 2. In mode 4, the voltage polarity sensor signal is high and the Hall effect sensor signal is high.

If the voltage polarity sensor signal changes, resulting in the voltage polarity sensor signal being low and the Hall effect sensor signal being high, the motor controller 408 switches the DC power switches Q1A, Q1B, Q2A, Q2B, Q3A, Q3B, Q4A, and Q4B on, off, and/or in PWM mode according to mode 3 to start drawing current from Line 2 without changing the direction of current in the windings.

In the second dock cycle, the motor controller 408 stops operating the fourth DC power switch Q2B in PWM mode and turns it on. Next, the motor controller 408 turns the first DC power switch Q1A on and then turns off the sixth DC power switch Q3B. The motor controller 408 operates the seventh DC power switch Q4A in PWM mode. At this point, the multispeed AC machine 302A is in mode 3 with the first DC power switch Q1A and the fourth DC power switch Q2B always on while the motor controller 408 is operating the seventh DC power switch Q4A in PWM mode. The motor controller 408 switching operations are shown in Table 12.

TABLE 12

| | CC | CC | CC | CC | CC |
|---|---|---|---|---|---|
| Switch | 1 | 2 | 3 | 4 | 5 |
| Q1A | 0 | 0 | 1 | 1 | 1 |
| Q1B | 0 | 0 | 0 | 0 | 0 |
| Q2A | 0 | 0 | 0 | 0 | 0 |
| Q2B | PWM | 1 | 1 | 1 | 1 |
| Q3A | 0 | 0 | 0 | 0 | 0 |
| Q3B | 1 | 1 | 1 | 0 | 0 |
| Q4A | 1 | 1 | 1 | 1 | PWM |
| Q4B | 0 | 0 | 0 | 0 | 0 |

When the Hall effect sensor signal changes, the motor controller 408 turns the DC power switches Q1A, Q1B, Q2A, Q2B, Q3A, Q3B, Q4A, and Q4B on, off, and/or in PWM mode as necessary to change the direction of the current through the windings Wa.

There may be a period of time where the motor controller 408 is waiting for that change in direction of the current to happen before it continues the switching process. Occasionally while waiting for the current to change direction, the line voltage polarity sensed by the voltage polarity sensor will also change, thereby requiring the motor controller 408 to implement a separate switching pattern to continue driving the current in the desired direction.

When the motor controller 408 is transitioning from mode 1 to mode 3 to make current flow from Line 1 through point A 326 to point B 328 instead of the current flowing from Line 1 through point B 328 to point A 326 and the line voltage polarity changes from Line 1 to Line 2, the higher voltage from Line 2 will cause an increase in current to flow from point B 328 to point A 326 instead of driving the current back towards zero. In this case, the motor controller 408 turns on the bi-directional switches Q2 332 and Q3 224 instead of turning on the bi-directional switches Q1 330 and Q4 336 to achieve the desired change in current direction and then transition to mode 4.

In the second clock cycle, the motor controller 408 turns the first DC power switch Q1A off and then turns the seventh DC power switch Q4A off. Two clock cycles of dead time (DT) are optionally inserted by the motor controller 408 to make sure both the first DC power switch Q1A and the seventh DC power switch Q4A are fully off before the motor controller turns the fifth DC power switch Q3A and the third DC power switch Q2A on to prevent shoot through between the first DC power switch Q1A and the fifth DC power switch Q3A or the third DC power switch Q2A and the seventh DC power switch Q4A. After the dead time, the motor controller 408 turns the fifth DC power switch Q3A on and then turns the third DC power switch Q2A on. Next, the motor controller 408 turns the second DC power switch Q1B off and then turns the eighth DC power switch Q4B off. Two more clock cycles of dead time are optionally inserted by the motor controller 408 to make sure both the second DC power switch Q1B and the eighth DC power switch Q4B are fully off before the motor controller turns the sixth DC power switch Q3B and the fourth DC power switch Q2B on to prevent shoot through between the second DC power switch Q1B and the sixth DC power switch Q3B or the fourth DC power switch Q2B and the eighth DC power switch Q4B. After the dead time, the motor controller 408 turns the sixth DC power switch Q3B on and then turns the fourth DC power switch Q2B on. At this point, bi-directional switches Q2 332 and Q3 334 are on and applying the higher voltage from Line 2 to point A 326.

Once the current has started flowing from Line 2, through point A 326 to point B 328, and out to Line 1 (I CH), the motor controller 408 continues the switching process. Next, the motor controller 408 turns the third DC power switch Q2A off and then turns the fifth DC power switch Q3A off. Two clock cycles of dead time are optionally inserted by the motor controller 408 to make sure the third DC power switch Q2A is fully off before the motor controller turns the seventh DC power switch Q4A on to prevent shoot through from happening between the third DC power switch Q2A and the seventh DC power switch Q4A. Following the dead time, the motor controller 408 turns the seventh DC power switch Q4A on and operates the fourth DC power switch Q2B in PWM mode. At this point, the multispeed AC machine 302A is in mode 4 with the sixth DC power switch Q3B and the seventh DC power switch Q4A on while the motor controller 408 is operating the fourth DC power switch Q2B in PWM mode. The motor controller 408 switching operations are shown in Tables 13A-13B.

TABLE 13A

| | CC | CC | CC | CC | CC | CC | CC | CC | CC | CC | CC | CC |
|---|---|---|---|---|---|---|---|---|---|---|---|---|
| Switch | 1 | 2 | 3 | 4 | 5 | 6 | 7 | 8 | 9 | 10 | 11 | 12 |
| Q1A | 1 | 0 | 0 | DT | DT | 0 | 0 | 0 | 0 | DT | DT | 0 |
| Q1B | 1 | 1 | 1 | DT | DT | 1 | 1 | 0 | 0 | DT | DT | 0 |
| Q2A | 0 | 0 | 0 | DT | DT | 0 | 1 | 1 | 1 | DT | DT | 1 |
| Q2B | 0 | 0 | 0 | DT | DT | 0 | 0 | 0 | 0 | DT | DT | 0 |
| Q3A | 0 | 0 | 0 | DT | DT | 1 | 1 | 1 | 1 | DT | DT | 1 |
| Q3B | 0 | 0 | 0 | DT | DT | 0 | 0 | 0 | 0 | DT | DT | 1 |
| Q4A | 1 | 1 | 0 | DT | DT | 0 | 0 | 0 | 0 | DT | DT | 0 |
| Q4B | 1 | 1 | 1 | DT | DT | 1 | 1 | 1 | 0 | DT | DT | 0 |

TABLE 13B

| | CC | CC | CC | CC | CC | CC | CC | CC |
|---|---|---|---|---|---|---|---|---|
| Switch | 13 | 14 | 15 | 16 | 17 | 18 | 19 | 20 |
| Q1A | 0 | I CH | 0 | 0 | DT | DT | 0 | 0 |
| Q1B | 0 | I CH | 0 | 0 | DT | DT | 0 | 0 |
| Q2A | 1 | I CH | 0 | 0 | DT | DT | 0 | 0 |
| Q2B | 1 | I CH | 1 | 1 | DT | DT | 1 | PWM |
| Q3A | 1 | I CH | 1 | 0 | DT | DT | 0 | 0 |
| Q3B | 1 | I CH | 1 | 1 | DT | DT | 1 | 1 |
| Q4A | 0 | I CH | 0 | 0 | DT | DT | 1 | 1 |
| Q4B | 0 | I CH | 0 | 0 | DT | DT | 0 | 0 |

When the motor controller 408 is transitioning from mode 2 to mode 4 to make current flow from Line 2 through point A 326 to point B 328 instead of the current flowing from Line 2 through point B 328 to point A 326, and the line voltage polarity changes from Line 2 to Line 1, the higher voltage from Line 1 may cause an increase in current from point B 328 to point A 326 instead of driving that current back towards zero. In this case, the motor controller 408 turns on the bi-directional switches Q1 and Q4 on instead of turning on the bi-directional switches Q2 and Q3 to achieve the desired change in current and then transition to mode 3.

In the second clock cycle, the motor controller 408 turns the sixth DC power switch Q3B off and then turns the fourth DC power switch Q2B off. Two clock cycles of dead time are optionally inserted by the motor controller 408 to make sure both the fourth DC power switch Q2B and the sixth DC power switch Q3B are fully off before the motor controller turns the second DC power switch Q1B and the eighth DC power switch Q4B on to prevent shoot through between the second DC power switch Q1B and the sixth DC power switch Q3B or the fourth DC power switch Q2B and the eighth DC power switch Q4B. After the dead time, the motor controller 408 turns the second DC power switch Q1B on and then turns the eighth DC power switch Q4B on. Next, the motor controller 408 turns the third DC power switch Q2A off and then turns the fifth DC power switch Q3A off. Two more clock cycles of dead time are optionally inserted by the motor controller 408 to make sure both the third DC power switch Q2A and the fifth DC power switch Q3A are fully off before the motor controller turns the first DC power switch Q1A and the seventh DC power switch Q4A on to prevent shoot through between the first DC power switch Q1A and the fifth DC power switch Q3A or the third DC power switch Q2A and the seventh DC power switch Q4A. After the dead time, the motor controller 408 turns the seventh DC power switch Q4A on and then turns the first DC power switch Q1A on. At this point, the bi-directional switches Q1 330 and Q4 336 are on and applying the higher voltage from Line 1 to point A 326.

Once the current has started flowing from Line 1, through point A 326 to point B 328, and out to Line 2 (I CH), the motor controller 408 continues the switching process. Next, the motor controller 408 turns the eighth DC power switch Q4B off and then turns the second DC power switch Q1B off. Two clock cycles of dead time are optionally inserted by the motor controller 408 to make sure the eighth DC power switch Q4B is fully off before the motor controller turns the fourth DC power switch Q2B on to prevent shoot through from happening between the fourth DC power switch Q2B and the eighth DC power switch Q4B. Following the dead time, the motor controller 408 turns the fourth DC power switch Q2B on and operates the seventh DC power switch Q4A in PWM mode. At this point, the multispeed AC machine 302A is in mode 3 with the first DC power switch Q1A and the fourth DC power switch Q2B on while the motor controller 408 is operating the seventh DC power switch Q4A in PWM mode. The motor controller 408 switching operations are shown in Tables 14A-14B.

TABLE 14A

| | CC | CC | CC | CC | CC | CC | CC | CC | CC | CC | CC | CC |
|---|---|---|---|---|---|---|---|---|---|---|---|---|
| Switch | 1 | 2 | 3 | 4 | 5 | 6 | 7 | 8 | 9 | 10 | 11 | 12 |
| Q1A | 0 | 0 | 0 | DT | DT | 0 | 0 | 0 | 0 | DT | DT | 0 |
| Q1B | 0 | 0 | 0 | DT | DT | 1 | 1 | 1 | 1 | DT | DT | 1 |
| Q2A | 1 | 1 | 1 | DT | DT | 1 | 1 | 0 | 0 | DT | DT | 0 |
| Q2B | 1 | 1 | 0 | DT | DT | 0 | 0 | 0 | 0 | DT | DT | 0 |
| Q3A | 1 | 1 | 1 | DT | DT | 1 | 1 | 1 | 0 | DT | DT | 0 |
| Q3B | 1 | 0 | 0 | DT | DT | 0 | 0 | 0 | 0 | DT | DT | 0 |
| Q4A | 0 | 0 | 0 | DT | DT | 0 | 0 | 0 | 0 | DT | DT | 1 |
| Q4B | 0 | 0 | 0 | DT | DT | 0 | 1 | 1 | 1 | DT | DT | 1 |

TABLE 14B

| | CC | CC | CC | CC | CC | CC | CC | CC |
|---|---|---|---|---|---|---|---|---|
| Switch | 13 | 14 | 15 | 16 | 17 | 18 | 19 | 20 |
| Q1A | 1 | I CH | 1 | 1 | DT | DT | 1 | 1 |
| Q1B | 1 | I CH | 1 | 0 | DT | DT | 0 | 0 |
| Q2A | 0 | I CH | 0 | 0 | DT | DT | 0 | 0 |
| Q2B | 0 | I CH | 0 | 0 | DT | DT | 1 | 1 |
| Q3A | 0 | I CH | 0 | 0 | DT | DT | 0 | 0 |
| Q3B | 0 | I CH | 0 | 0 | DT | DT | 0 | 0 |
| Q4A | 1 | I CH | 1 | 1 | DT | DT | 1 | PWM |
| Q4B | 1 | I CH | 0 | 0 | DT | DT | 0 | 0 |

When the motor controller 408 is transitioning from mode 3 to mode 1 to make current flow from Line 1 through point B 328 to point A 326 instead of the current flowing from Line 1 through point A 326 to point B 328 and the line voltage polarity changes, the higher voltage from Line 2 may cause an increase in current from point A 326 to point B 328 instead of driving that current back towards zero. The motor controller 408 turns on the bi-directional switches Q1 330 and Q4 336 instead of turning on the bi-directional switches Q2 332 and Q3 334 to achieve the desired change in current and then transition to mode 2.

In the second clock cycle, the motor controller 408 turns the fifth DC power switch Q3A off and then turns the third DC power switch Q2A off. Two clock cycles of dead time are optionally inserted by the motor controller 408 to make sure both the third DC power switch Q2A and the fifth DC power switch Q3A are fully off before the motor controller turns the first DC power switch Q1A and the seventh DC power switch Q4A on to prevent shoot through between the first DC power switch Q1A and the fifth DC power switch Q3A or the third DC power switch Q2A and the seventh DC power switch Q4A. After the dead time, the motor controller 408 turns the first DC power switch Q1A on and then turns the seventh DC power switch Q4A on. Next, the motor controller 408 turns the sixth DC power switch Q3B off and then turns the fourth DC power switch Q2B off. Two more clock cycles of dead time are optionally inserted by the motor controller 408 to make sure both the fourth DC power switch Q2B and the sixth DC power switch Q3B are fully off before the motor controller turns the second DC power switch Q1B and the eighth DC power switch Q4B on to prevent shoot through between the second DC power switch Q1B and the sixth DC power switch Q3B or the fourth DC power switch Q2B and the eighth DC power switch Q4B. After the dead time, the motor controller 408 turns the second DC power switch Q1B on and then turns the eighth DC power switch Q4B on. At this point, the bi-directional switches Q1 330 and Q4 336 are on and applying the higher voltage from Line 2 to point B 328.

Once the current has started flowing from Line 2, through point B 328 to point A 326, and out to Line 1 (I CH), the motor controller 408 continues the switching process. Next, the motor controller 408 turns the first DC power switch Q1A off and then turns the seventh DC power switch Q4A off. Two clock cycles of dead time are optionally inserted by the motor controller 408 to make sure the first DC power switch Q1A is fully off before the motor controller turns the fifth DC power switch Q3A on to prevent shoot through from happening between the first DC power switch Q1A and the fifth DC power switch Q3A. Following the dead time, the motor controller 408 turns the fifth DC power switch Q3A on and motor controller operates the second DC power switch Q1B in PWM mode. At this point, the multispeed AC machine 302A is in mode 2 with the fifth DC power switch Q3A and the eighth DC power switch Q4B on while the motor controller 408 operates the second DC power switch Q1B in PWM mode. The motor controller 408 switching operations are shown in Tables 15A-15B.

TABLE 15A

| | CC | CC | CC | CC | CC | CC | CC | CC | CC | CC | CC | CC | CC |
|---|---|---|---|---|---|---|---|---|---|---|---|---|---|
| Switch | 1 | 2 | 3 | 4 | 5 | 6 | 7 | 8 | 9 | 10 | 11 | 12 | 13 |
| Q1A | 0 | 0 | 0 | DT | DT | 1 | 1 | 1 | 1 | DT | DT | 1 | 1 |
| Q1B | 0 | 0 | 0 | DT | DT | 0 | 0 | 0 | 0 | DT | DT | 1 | 1 |
| Q2A | 1 | 1 | 0 | DT | DT | 0 | 0 | 0 | 0 | DT | DT | 0 | 0 |
| Q2B | 1 | 1 | 1 | DT | DT | 1 | 1 | 1 | 0 | DT | DT | 0 | 0 |
| Q3A | 1 | 0 | 0 | DT | DT | 0 | 0 | 0 | 0 | DT | DT | 0 | 0 |
| Q3B | 1 | 1 | 1 | DT | DT | 1 | 1 | 0 | 0 | DT | DT | 0 | 0 |
| Q4A | 0 | 0 | 0 | DT | DT | 0 | 1 | 1 | 1 | DT | DT | 1 | 1 |
| Q4B | 0 | 0 | 0 | DT | DT | 0 | 0 | 0 | 0 | DT | DT | 0 | 1 |

TABLE 15B

| | CC | CC | CC | CC | CC | CC | CC |
|---|---|---|---|---|---|---|---|
| Switch | 14 | 15 | 16 | 17 | 18 | 19 | 20 |
| Q1A | I CH | 0 | 0 | DT | DT | 0 | 0 |
| Q1B | I CH | 1 | 1 | DT | DT | 1 | PWM |
| Q2A | I CH | 0 | 0 | DT | DT | 0 | 0 |
| Q2B | I CH | 0 | 0 | DT | DT | 0 | 0 |
| Q3A | I CH | 0 | 0 | DT | DT | 1 | 1 |
| Q3B | I CH | 0 | 0 | DT | DT | 0 | 0 |
| Q4A | I CH | 1 | 0 | DT | DT | 0 | 0 |
| Q4B | I CH | 1 | 1 | DT | DT | 1 | 1 |

When the motor controller 408 is transitioning from mode 4 to mode 2 to make current flow from Line 2 through point B 328 to point A 326 instead of the current flowing from Line 2 through point A 326 to point B 328 and the line voltage polarity changes, the higher voltage from Line 1 may cause an increase in current from point A 326 to point B 328 instead of driving that current back towards zero. The motor controller 408 turns on the bi-directional switches Q2 332 and Q3 334 instead of turning on the bi-directional switches Q1 330 and Q4 336 to achieve the desired change in current and then transition to mode 1.

In the second clock cycle, the motor controller 408 turns the second DC power switch Q1B off and then turns the eighth DC power switch Q4B off. Two clock cycles of dead time (DT) are optionally inserted by the motor controller 408 to make sure both the second DC power switch Q1B and the eighth DC power switch Q4B are fully off before the motor controller turns the fourth DC power switch Q2B and the sixth DC power switch Q3B on to prevent shoot through between the second DC power switch Q1B and the sixth DC power switch Q3B or the fourth DC power switch Q2B and the eighth DC power switch Q4B. After the dead time, the motor controller 408 turns the sixth DC power switch Q3B on and then turns the fourth DC power switch Q2B on. Next, the motor controller 408 turns the first DC power switch Q1A off and then turns the seventh DC power switch Q4A off. Two more clock cycles of dead time (DT) are optionally inserted by the motor controller 408 to make sure both the first DC power switch Q1A and the seventh DC power switch Q4A are fully off before the motor controller turns the third DC power switch Q2A and the fifth DC power switch Q3A on to prevent shoot through between the first DC power switch Q1A and the fifth DC power switch Q3A or the third DC power switch Q2A and the seventh DC power switch Q4A. After the dead time, the motor controller 408 turns the fifth DC power switch Q3A on and then turns the third DC power switch Q2A on. At this point, the bi-directional switches Q2 332 and Q3 334 are on and applying the higher voltage from Line 1 to point B 328.

Once the current has started flowing from Line 1, through point B 328 to point A 326, and out to Line 2, the motor controller 408 continues the switching process. Next, the motor controller 408 turns the sixth DC power switch Q3B off and then turns the fourth DC power switch Q2B off. Two clock cycles of dead time (DT) are optionally inserted by the motor controller 408 to make sure the sixth DC power switch Q3B is fully off before the motor controller turns the second DC power switch Q1B on to prevent shoot through from happening between the second DC power switch Q1B and the sixth DC power switch Q3B. Following the dead time, the motor controller 408 turns the second DC power switch Q1B on and operates the fifth DC power switch Q3A in PWM mode. At this point, the multispeed AC machine 302A is in mode 1 with the second DC power switch Q1B and the third DC power switch Q2A on while the motor controller 408 operates the fifth DC power switch Q3A in PWM mode. The motor controller 408 switching operations are shown in Tables 16A-16B.

TABLE 16A

| | CC | CC | CC | CC | CC | CC | CC | CC | CC | CC | CC | CC | CC |
|---|---|---|---|---|---|---|---|---|---|---|---|---|---|
| Switch | 1 | 2 | 3 | 4 | 5 | 6 | 7 | 8 | 9 | 10 | 11 | 12 | 13 |
| Q1A | 1 | 1 | 1 | DT | DT | 1 | 1 | 0 | 0 | DT | DT | 0 | 0 |
| Q1B | 1 | 0 | 0 | DT | DT | 0 | 0 | 0 | 0 | DT | DT | 0 | 0 |
| Q2A | 0 | 0 | 0 | DT | DT | 0 | 0 | 0 | 0 | DT | DT | 0 | 1 |
| Q2B | 0 | 0 | 0 | DT | DT | 0 | 1 | 1 | 1 | DT | DT | 1 | 1 |
| Q3A | 0 | 0 | 0 | DT | DT | 0 | 0 | 0 | 0 | DT | DT | 1 | 1 |
| Q3B | 0 | 0 | 0 | DT | DT | 1 | 1 | 1 | 1 | DT | DT | 1 | 1 |
| Q4A | 1 | 1 | 1 | DT | DT | 1 | 1 | 1 | 0 | DT | DT | 0 | 0 |
| Q4B | 1 | 1 | 0 | DT | DT | 0 | 0 | 0 | 0 | DT | DT | 0 | 0 |

TABLE 16B

| | CC | CC | CC | CC | CC | CC | CC |
|---|---|---|---|---|---|---|---|
| Switch | 14 | 15 | 16 | 17 | 18 | 19 | 20 |
| Q1A | I CH | 0 | 0 | DT | DT | 0 | 0 |
| Q1B | I CH | 0 | 0 | DT | DT | 1 | 1 |
| Q2A | I CH | 1 | 1 | DT | DT | 1 | 1 |
| Q2B | I CH | 1 | 0 | DT | DT | 0 | 0 |
| Q3A | I CH | 1 | 1 | DT | DT | 1 | PWM |
| Q3B | I CH | 0 | 0 | DT | DT | 0 | 0 |
| Q4A | I CH | 0 | 0 | DT | DT | 0 | 0 |
| Q4B | I CH | 0 | 0 | DT | DT | 0 | 0 |

The motor controller 408 can turn on either the combination of bi-directional switches Q1 330 and Q4 336 or the combination of bi-directional switches Q2 332 and Q3 334 for full synchronous operation of the multispeed AC machine 302A and the machine. Even though there are only two options for synchronous operation, the motor controller 408 has four switching patterns to switch the multispeed AC machine 302A from each of the four modes into the synchronous state.

In mode 1, the second DC power switch Q1B and the third DC power switch Q2A are on while the motor controller 408 operates the fifth DC power switch Q3A in PWM mode. In the second dock cycle, the motor controller 408 stops operating the fifth DC power switch Q3A in PWM mode and turns the fifth DC power switch Q3A on. Then, the motor controller 408 turns the second DC power switch Q1B off. Two clock cycles of dead time (DT) are optionally inserted by the motor controller 408 to make sure the second DC power switch Q1B is fully off before the motor controller turns the sixth DC power switch Q3B on to prevent shoot through between the second DC power switch Q1B and the sixth DC power switch Q3B. After the dead time, the motor controller 408 turns the fourth DC power switch Q2B on and then turns the fifth DC power switch Q3A on. At this point, the multispeed AC machine 302A is operating in a full synchronous state with no switching with bi-directional switches Q2 332 and Q3 334 always on. The motor controller 408 switching operations are shown in Table 17.

TABLE 17

| | CC | CC | CC | CC | CC | CC | CC |
|---|---|---|---|---|---|---|---|
| Switch | 1 | 2 | 3 | 4 | 5 | 6 | 7 |
| Q1A | 0 | 0 | 0 | DT | DT | 0 | 0 |
| Q1B | 1 | 1 | 0 | DT | DT | 0 | 0 |
| Q2A | 1 | 1 | 1 | DT | DT | 1 | 1 |
| Q2B | 0 | 0 | 0 | DT | DT | 1 | 1 |
| Q3A | PWM | 1 | 1 | DT | DT | 1 | 1 |
| Q3B | 0 | 0 | 0 | DT | DT | 0 | 1 |
| Q4A | 0 | 0 | 0 | DT | DT | 0 | 0 |
| Q4B | 0 | 0 | 0 | DT | DT | 0 | 0 |

In mode 2, the fifth DC power switch Q3A and the eighth DC power switch Q4B are on while the motor controller 408 operates the second DC power switch Q1B in PWM mode. In the second clock cycle, the motor controller 408 stops operating the second DC power switch Q1B in PMW mode and turns the second DC power switch Q1B on. Then, the motor controller 408 turns the fifth DC power switch Q3A off. Two clock cycles of dead time (DT) are optionally inserted by the motor controller 408 to make sure the fifth DC power switch Q3A is fully off before the motor controller turns the first DC power switch Q1A on to prevent shoot through between the first DC power switch Q1A and the fifth DC power switch Q3A. After the dead time, the motor controller 408 turns the seventh DC power switch Q4A on and then turns the first DC power switch Q1A on. At this point, the multispeed AC machine 302A is operating in a full synchronous state with no switching with bi-directional switches Q1 330 and Q4 336 always on. The motor controller 408 switching operations are shown in Table 18.

TABLE 18

| | CC | CC | CC | CC | CC | CC | CC |
|---|---|---|---|---|---|---|---|
| Switch | 1 | 2 | 3 | 4 | 5 | 6 | 7 |
| Q1A | 0 | 0 | 0 | DT | DT | 0 | 1 |
| Q1B | PWM | 1 | 1 | DT | DT | 1 | 1 |
| Q2A | 0 | 0 | 0 | DT | DT | 0 | 0 |
| Q2B | 0 | 0 | 0 | DT | DT | 0 | 0 |
| Q3A | 1 | 1 | 0 | DT | DT | 0 | 0 |
| Q3B | 0 | 0 | 0 | DT | DT | 0 | 0 |
| Q4A | 0 | 0 | 0 | DT | DT | 1 | 1 |
| Q4B | 1 | 1 | 1 | DT | DT | 1 | 1 |

In mode 3, the first DC power switch Q1A and the fourth DC power switch Q2B are on while the motor controller 408 operates the seventh DC power switch Q4A in PWM mode. In the second clock cycle, the motor controller 408 stops operating the seventh DC power switch Q4A in PWM mode and turns the seventh DC power switch Q4A on. Then, the motor controller 408 turns the fourth DC power switch Q2B off. Two clock cycles of dead time (DT) are optionally inserted by the motor controller 408 to make sure the fourth DC power switch Q2B is fully off before the motor controller turns the eighth DC power switch Q4B on to prevent shoot through between the fourth DC power switch Q2B and the eighth DC power switch Q4B. After the dead time, the motor controller 408 turns the second DC power switch Q1B on and then turns the eighth DC power switch Q4B on. At this point, the multispeed AC machine 302A is operating in a full synchronous state with no switching with bi-directional switches Q1 330 and Q4 336 always on. The motor controller 408 switching operations are shown in Table 19.

TABLE 19

| | CC | CC | CC | CC | CC | CC | CC |
|---|---|---|---|---|---|---|---|
| Switch | 1 | 2 | 3 | 4 | 5 | 6 | 7 |
| Q1A | 1 | 1 | 1 | DT | DT | 1 | 1 |
| Q1B | 0 | 0 | 0 | DT | DT | 1 | 1 |
| Q2A | 0 | 0 | 0 | DT | DT | 0 | 0 |
| Q2B | 1 | 1 | 0 | DT | DT | 0 | 0 |
| Q3A | 0 | 0 | 0 | DT | DT | 0 | 0 |
| Q3B | 0 | 0 | 0 | DT | DT | 0 | 0 |
| Q4A | PWM | 1 | 1 | DT | DT | 1 | 1 |
| Q4B | 0 | 0 | 0 | DT | DT | 0 | 1 |

In mode 4, the sixth DC power switch Q3B and the seventh DC power switch Q4A are on while the motor controller 408 operates the fourth DC power switch Q2B in PWM mode. In the second clock cycle, the motor controller 408 stops operating the fourth DC power switch Q2B in PWM mode and turns the fourth DC power switch Q2B on. Then, the motor controller 408 turns the seventh DC power switch Q4A off. Two clock cycles of dead time (DT) are optionally inserted by the motor controller 408 to make sure the seventh DC power switch Q4A is fully off before the motor controller turns the third DC power switch Q2A on to prevent shoot through between the third DC power switch Q2A and the seventh DC power switch Q4A. After the dead time, the motor controller 408 turns the fifth DC power switch Q3A on and then turns the third DC power switch Q2A on. At this point, the multispeed AC machine 302A is operating in a full synchronous state with no switching with bi-directional switches Q2 332 and Q3 334 always on. The motor controller 408 switching operations are shown in Table 20.

TABLE 20

| | CC | CC | CC | CC | CC | CC | CC |
|---|---|---|---|---|---|---|---|
| Switch | 1 | 2 | 3 | 4 | 5 | 6 | 7 |
| Q1A | 0 | 0 | 0 | DT | DT | 0 | 0 |
| Q1B | 0 | 0 | 0 | DT | DT | 0 | 0 |
| Q2A | 0 | 0 | 0 | DT | DT | 0 | 1 |
| Q2B | PWM | 1 | 1 | DT | DT | 1 | 1 |
| Q3A | 0 | 0 | 0 | DT | DT | 1 | 1 |
| Q3B | 1 | 1 | 1 | DT | DT | 1 | 1 |
| Q4A | 1 | 1 | 0 | DT | DT | 0 | 0 |
| Q4B | 0 | 0 | 0 | DT | DT | 0 | 0 |

When the motor controller 408 is to take the multispeed AC machine 302A out of synchronous operation, either due to instability or a change in the speed setting, the motor controller waits for the next current zero crossing and turns all of the switches off. This allows the motor controller 408 to then operate in any of the modes without needing a specific switching pattern to get into the modes.

### Output Torque Control

In one embodiment, the motor controller 408 operates selected DC power switches Q1A, Q1B, Q2A, Q2B, Q3A, Q3B, Q4A, and/or Q4B in PMW mode by generating PWM signals with a constant duty cycle on the line voltage and with no wave shaping to the selected DC power switches. The initial duty cycle of the PWM signals has a selected percentage, such as 21.5% or another number between 10% and 50%, when the motor controller 408 starts, and the initial duty cycle is increased or decreased to achieve the desired set speed. The motor controller 408 will not control the multispeed AC machine 302A and machine for full synchronous mode in this embodiment until the duty cycle has been increased up to 100%.

The motor controller 408 can operate the circuit in synchronous mode by closing either Q1 (i.e., Q1A and Q1B) or Q4 (i.e., Q4A and Q4B) and opening either Q2 (i.e., Q2A and Q2B) or Q3 (i.e., Q3A and Q3B. For example, the motor controller 408 can operate the circuit in synchronous mode by closing Q1 and opening Q2, closing Q1 and opening Q3, closing Q4 and opening Q2, or closing Q4 and opening Q3.

In one embodiment, the Hall effect sensor location, which is centered between two stator teeth, is approximately 12.5 degrees retarded against the BEMF when the machine is spun in either direction. The motor controller 408 accounts for this Hall effect sensor location in one embodiment by modifying the actual Hall effect sensor signal by a minimum advance of 12.5 degrees. There are two other variables that determine how far the modified Hall effect sensor signal is advanced when compared to the actual Hall effect sensor signal. These variables are called boost and offset.

In this embodiment, the boost variable has a minimum value tied to each speed setting. For example, the boost variable may have a value between zero and 400 microseconds, dependent on the speed setting of the machine. For example, at a 600 rpm speed setting, the minimum value of the boost variable is a first value, such as 0 in one example. At a 750 rpm speed setting, the minimum value of the boost variable is a second value, such as 98 microseconds in one example. At a 900 rpm speed setting, the minimum value of the boost variable is a third value, such as 196 microseconds in one example. At a 1040 rpm speed setting, the minimum value of the boost variable is a fourth value, such as 294 microseconds in one example. At a 1200 rpm speed setting, the minimum value of the boost variable is a fifth value, such as 392 microseconds in one example. The motor controller 408 advances the actual Hall effect sensor signal with the value of the boost variable to result in the modified Hall effect sensor signal. The boost variable stays at its minimum value until the PWM signal has reached a 100% duty cycle. After the PWM signal reaches 100% duty cycle, the motor controller 408 will start to increase the value of the boost variable by selected amounts, which increases the advance, to allow more current to be forced into the windings Wa to create more torque.

In this embodiment, the offset variable is based on the actual line voltage measurement and whether the actual line voltage is increasing or decreasing and the actual current measurement at a given time. This offset variable changes the advance on the modified Hall effect sensor signal so that the motor controller 408 switches between modes 1-4 at the right time to get the current through the windings Wa back to zero at the BEMF zero crossing. For example, if the current through the windings Wa is 3 amps as the motor is approaching the BEMF zero crossing, the motor controller 408 will switch modes earlier to drive the current down to zero at the BEMF zero crossing. The software generated hall signal is advance That is why the line voltage measurement is used because the voltage applied to the windings Wa determines how fast the current can change. If the current through windings Wa is at 0 amps as the current is approaching the BEMF zero crossing, which can happen if the BEMF value is higher than the available line voltage, the offset variable is zero so that the motor controller 408 doesn't switch modes too soon and result in voltage and current that is out of phase with the BEMF being applied to the multispeed AC machine 302A.

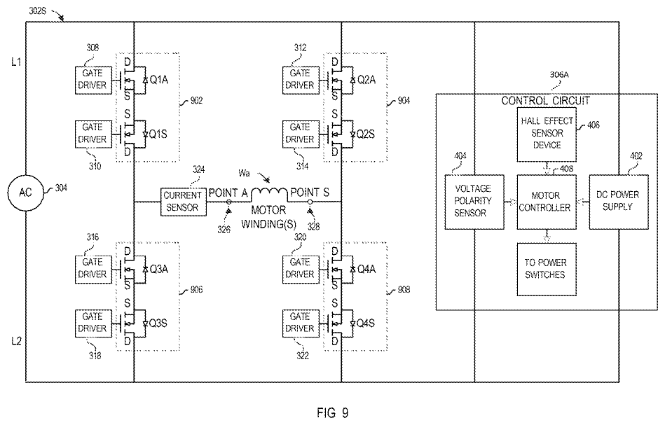

FIG. 9 depicts an exemplary embodiment of a multispeed AC machine circuit 302B with the DC power switches Q1A, Q1B, Q2A, Q2B, Q3A, Q3B, Q4A, and Q4B without external diodes configured in opposite current passing directions to form bi-directional switches. In the embodiment of FIG. 9, the first DC power switch Q1A is configured in series with and in the opposite current passing direction of the second DC power switch Q1B to form a first AC bi-directional power switch Q1 902. The third DC power switch Q2A is configured in series with and in the opposite current passing direction of the fourth DC power switch Q2B to form a second AC bi-directional power switch Q2 904. The fifth DC power switch Q3A is configured in series with and in the opposite current passing direction of the sixth DC power switch Q3B to form a third AC bi-directional power switch Q3 906. The seventh DC power switch Q4A is configured in series with and in the opposite current passing direction of the eighth DC power switch Q4B to form a fourth AC bi-directional power switch Q4 908. The multispeed AC machine circuit 302B of FIG. 9 operates the same as the multispeed AC machine circuit 302A of FIG. 4, as described above. This configuration uses the body diode in the DC power switch Q1A, Q1B, Q2A, Q2B, Q3A, Q3B, Q4A, and Q4B instead of an external power diode.

In the embodiment of FIG. 9, the drain of the first DC power switch Q1A is connected to the first side lead L1 or Line 1. The source of the first DC power switch Q1A is connected to the source of the second DC power switch Q1B (and therefore the two DC power switches Q1A and Q1B are configured in opposite current passing directions).

The drain of the second DC power switch Q1B is connected to the drain of the fifth DC power switch Q3A and the first side of the current sensor 324. When the current sensor 324 is not present, the drain of the second DC power switch Q1B is connected to the drain of the fifth DC power switch Q3A and the first side of the one or more windings Wa at point A 326. The source of the second DC power switch Q1B is connected to the source of the first DC power switch Q1A (and therefore the two DC power switches Q1A and Q1B are configured in opposite current passing directions).

The drain of the third DC power switch Q2A is connected to the first side lead L1 or Line 1. The source of the third DC power switch Q2A is connected to the source of the fourth DC power switch Q2B (and therefore the two DC power switches Q2A and Q2B are configured in opposite current passing directions).

The drain of the fourth DC power switch Q2B is connected to the drain of the seventh DC power switch Q4A and the second side of the one or more windings Wa at point B 328. The source of the fourth DC power switch Q2B is connected to the source of the third DC power switch Q2A (and therefore the two DC power switches Q2A and Q2B are configured in opposite current passing directions).

The drain of the fifth DC power switch Q3A is connected to the drain of the second DC power switch Q1B and the first side of the current sensor 324. When the current sensor 324 is not present, the drain of the fifth DC power switch Q3A is connected to the drain of the second DC power switch Q1B and the first side of the one or more windings Wa at point A 326. The source of the fifth DC power switch Q3A is connected to the source of the sixth DC power switch Q3B (and therefore the two DC power switches Q3A and Q3B are configured in opposite current passing directions).

The drain of the sixth DC power switch Q3B is connected to the second side lead L2 or Line 2. The source of the sixth DC power switch Q3B is connected to the source of the fifth DC power switch Q3A (and therefore the two DC power switches Q3A and Q3B are configured in opposite current passing directions).

The drain of the seventh DC power switch Q4A is connected to the drain of the fourth DC power switch Q3B and the second side of the one or more windings Wa at point B 328. The source of the seventh DC power switch Q4A is connected to the source of the eighth DC power switch Q4B (and therefore the two DC power switches Q4A and Q4B are configured in opposite current passing directions).

The drain of the eighth DC power switch Q4B is connected to the second side lead L2 or Line 2. The source of the eighth DC power switch Q4B is connected to the source of the seventh DC power switch Q4A (and therefore the two DC power switches Q4A and Q4B are configured in opposite current passing directions).

If the current sensor 324 is present in the multispeed AC machine circuit 302B, the first side of the current sensor is connected to the drains of the second DC power switch Q1B and the fifth DC power switch Q3A. The second side of the current sensor 324 is connected to the first side of the one or more windings Wa at point A 326.

The first side of the one or more windings Wa is connected to the second side of the current sensor 324 at point A 326. If the current sensor 324 is not present, the first side of the one or more windings Wa at point A 326 is connected to the drains of the second DC power switch Q1B and the fifth DC power switch Q3A. The second side of the one or more windings Wa is connected to the drains of the fourth DC power switch Q3B and the seventh DC power switch Q4A at point B 328.

The DC power supply 402 is connected between Line 1 and Line 2. The voltage polarity sensor 404 is connected between Line 1 and Line 2.

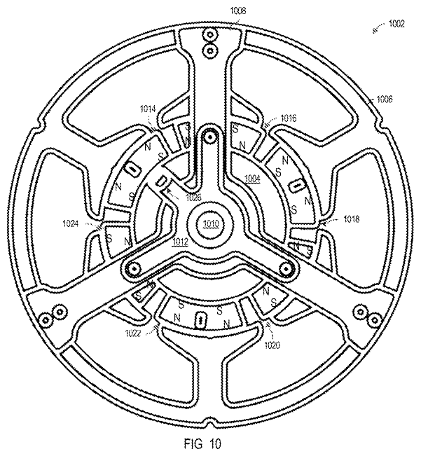

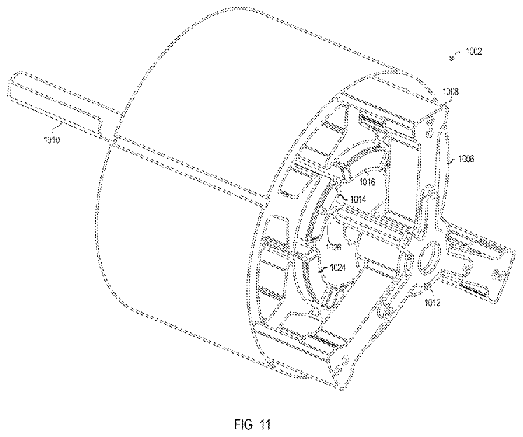

FIGS. 10-11 depict an example of a placement of a Hall effect sensor device 406 of a control circuit 306A for a motor 1002. The motor 1002 has a rotor 1004 and a stator 1006. A tripod 1008 holds a rear bearing/shaft 1010 in place. A Hall effect sensor device holder or mount 1012 is mounted to the tripod 1008, and the Hall effect sensor device 406 is mounted on the Hall effect sensor device mount.

The rotor 1004 has rotor magnets 1014-1024 that are magnetized radially through the center of the magnet. The rotor magnets 1014, 1018, and 1022 with the mark on top have a north pole on the outside diameter (OD) and a south pole on the inside diameter (ID). The rotor magnets 1016, 1020, and 1024 with no marking have a south pole on the outside diameter (OD) and a north pole on the inside diameter (ID).

In the example of FIGS. 10-11, the Hall effect sensor device 406 is placed at an inner edge of the rotor magnets 1014-1024 so it detects a magnetic pole of the rotor magnets that is opposite of the magnetic pole facing the stator 1006. In this example, the Hall effect sensor device 406 has two output signals: (1) a high output signal indicating a north magnetic pole is facing the stator 1006 or (2) a low output signal indicating a south magnetic pole is facing the stator.

FIG. 12 depicts another example of a placement of a Hall effect sensor device 406 of a control circuit 306A for a motor 1202. The motor 1202 has a rotor 1204 and a stator 1206. A tripod 1208 holds a rear bearing/shaft 1210 in place. A Hall effect sensor device 406 holder or mount 1212 is mounted to the tripod 1208, and the Hall effect sensor device 406 is mounted on the Hall effect sensor device mount.

The rotor 1204 has rotor magnets 1214-1224 that are magnetized radially through the center of the magnet. The rotor magnets 1214, 1218, and 1222 with the mark on top have a north pole on the outside diameter (OD) and a south pole on the inside diameter (ID). The rotor magnets 1216, 1220, and 1224 with no marking have a south pole on the outside diameter (OD) and a north pole on the inside diameter (ID).

The stator 1206 has stator teeth 1226-1236. The holder 1212 and the tripod 1208 keep the face of the Hall effect sensor device 406 just inside of the edge of a magnet attached to a rotor 1204 and aligned with the stator 1206 so that the Hall effect sensor 406 is between two stator teeth 1234 and 1236. In this example, the location of the Hall effect sensor device 406 relative to the stator 1206 results in a high Hall effect sensor signal or a low Hall effect sensor signal that is aligned with the back electromotive force (BEMF) of the motor 1202 in the same position no matter which way the motor is spun. This allows the motor 1202 to operate in either direction with only one Hall effect sensor device 406. For example, if counter clockwise operation is desired, the Hall effect sensor signal can be used as it is, with the Hall effect sensor device outputting a high Hall effect sensor signal when the BEMF is high when the motor is spun counter-clockwise. For clockwise operation, the Hall effect sensor signal is inverted by the motor controller 406 (see FIG. 4 and FIG. 9). An inverted Hall effect sensor signal is high when the BEMF is high and the motor 1202 is spun clockwise, since spinning the motor the opposite direction inverts the BEMF. Once the motor 1202 is spinning the intended direction, the Hall effect sensor signal can be shifted by the motor controller 408 (see FIG. 4 and FIG. 9) to provide optimum performance. The Hall effect sensor signal is advanced for increased torque, and it is retarded for decreased torque.

In one embodiment, the multispeed AC machine circuit 302A can operate in three different modes in one embodiment: starting mode, synchronous speed mode, and off-synchronous speed mode.

Starting mode in this embodiment is used for start-up of the motor in which the multispeed AC machine circuit 302A is used. Starting mode can be operated in multiple different ways, including pulse-width modulation, delayed firing angle with zero current shutoff, or using a second winding. The different starting modes are used to limit starting current and torque to provide smooth stable operation.

In synchronous speed mode in this embodiment, the motor is operating at synchronous speed. Synchronous speed rotations per minute (RPM) can be determined by taking the line frequency in Hertz divided by the number of rotor pole pairs (1 north pole and 1 south pole is equal to 1 pole pair) and multiplied by 60, the number of seconds in a minute. For example a six pole motor (3 north poles and 3 south poles) running on a 60 Hz supply would have a synchronous speed of 1200 RPM because 60 Hz/3 pole pairs*60 sec 1200 RPM. In synchronous speed mode, one pair of bi-directional power switches Q1/Q4 or Q2/Q3 is closed and the other pair of bi-directional power switches Q2/Q3 or Q1/Q4 is open, allowing continuous alternating current flow through the windings Wa.

Delayed firing angle with zero current shutoff mode may be used in starting mode to limit starting current/torque and also in off-synchronous speed mode. Delayed firing angle with zero current shutoff entails waiting until the sine wave of the AC voltage is past a certain point before dosing any DC power switches. For example, once voltage is at the peak of the sine wave, one or more DC power switches may be closed to allow current flow through the winding Wa. In one example, once current flow through the winding Wa is at zero, the motor controller 408 will open all DC power switches Q1A, Q1B, Q2A, Q2B, Q3A, Q3B, Q4A, and Q4B and wait until the next peak of the sine wave is reached before the motor controller will close any DC power switches. In this example, the effective RMS value of the applied voltage will be reduced to 50% of the line voltage because only the second half of the sine wave voltage is applied to the winding Wa. The effective RMS voltage applied to the winding Wa in this mode may be adjusted by how much of the sine wave voltage is applied to the winding.

Off-synchronous speed mode in this embodiment is used when the motor is operating at less than synchronous speed. Off-synchronous speed mode may be operated at a speed that is less than or more than synchronous mode. Off-synchronous speed mode may be operated multiple ways by the motor controller 408, including using the delayed firing angle with zero current shutoff to adjust the power applied to the winding Wa or adding additional windings and using a simplified circuit to operate at a fixed off-synchronous speed. The additional winding increases the BEMF to reduce the current draw and improve performance. The motor controller 408 controls the DC power switches Q1A, Q1B, Q2A, Q2B, Q3A, Q3B, Q4A, and Q4B based on the Hall effect sensor device signal and the voltage polarity sensor signal as described above.

FIGS. 13-14 depict exemplary embodiments of stator windings 1302. In the example embodiments of FIGS. 13-14, the stator windings 1302 are wound in two halves. The first half of the stator windings 1302 consists of the windings 1304-1308, respectively, wound around Tooth 1, Tooth 3, and Tooth 5, which are all wound in the clockwise direction if referenced from the center of the machine (e.g., motor) facing the stator teeth and connected in series. Together, these windings 1304-1308 make the first half of the windings, which is referred to as W1. The first half of the windings W1 has two ends. W1S refers to the start of the first half of the windings W1, and W1F refers to the end of the first half of the windings W1. The second half of the windings 1302 consists of the windings 1310-1314 wound around Tooth 2, Tooth 4, and Tooth 6, which are all wound in the counter-clockwise direction if referenced from the center of the machine (e.g., motor) facing the stator teeth and connected in series. Together, these windings 1310-1314 make the second half of the windings, which is referred to as W2. The second half of the windings W2 has two ends. W2S refers to the start of the second half of the windings W2, and W2F refers to the end of the second half of the windings W2.

Referring to FIG. 13, for operation of a motor at 115V, the first and second halves of the windings W1 and W2 are connected in parallel, the start ends of the first and second halves of the windings W1S and W2S are connected to point A 326 (see FIGS. 3-4), and the finish ends of the first and second halves of the windings W1F and W2F are connected to point B 328 (see FIGS. 3-4). This provides a lower back electromotive force (BEMF), inductance, and resistance for efficient synchronous operation at 115V.

Referring to FIG. 14, for operation of a motor at 230V, the second half of the windings W2 is connected in series with the first half of the windings W1 by connecting the start end of the second half of the windings W2S to the finish end of the first half of the windings Wt F. The start end of the first half of the windings W1S is connected to point A 326 (see FIGS. 3-4), and the finish end of the second half of the windings W2F is connected to point B 328 (see FIGS. 3-4). This series connection of the first half of the windings W1 and the second half of the windings W2 increases the BEMF, resistance, and inductance to provide efficient synchronous operation at 230V.

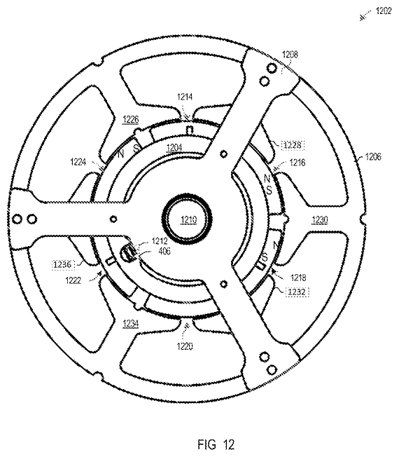

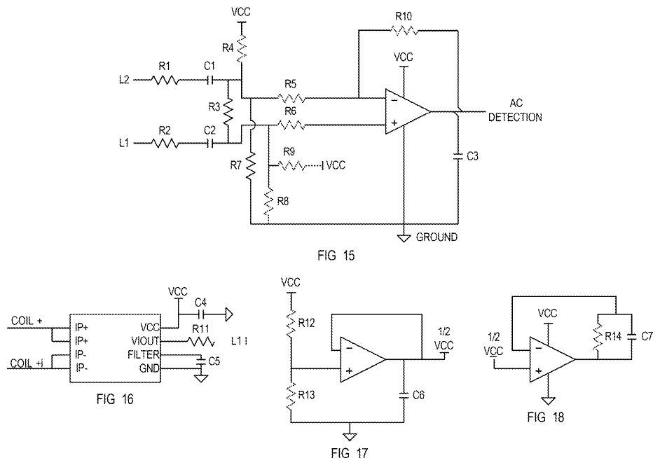

FIG. 15 depicts an exemplary embodiment of a voltage polarity sensor 404A. The AC line voltages Line 1 (L1) and Line 2 (L2) are coupled to the logic circuit of the voltage polarity sensor through high value resistors R1 and R2 and capacitors C1 and C2. A resistor network consisting of R3, R4, R5, R6, R7, R8 and R9 couples the capacitors C1 and C2 to an op-amp 1404. R4 and R7 create a voltage divider that level shifts the zero value of L2 to 1.65V or half of the logic supply voltage (VCC). R8 and R9 create a voltage divider that level shifts the zero value of L1 to 1.65V or half of the logic supply. R3 is connected to the logic (op-amp) side of C1 and C2 and ensures that those points are tied together creating a consistent voltage drop across R3. The output 1406 of the op-amp 1404 feeds back into the negative input of the op-amp through the feedback resistor R10. The output 1406 of the op-amp 1404 also connects to capacitor C3 to filter the output of the op-amp 1404. C3 is then tied to ground.

The output 1406 of the op-amp 1404 is a sine-wave signal that replicates the line voltage from L1 and L2 on a smaller scale with the zero-crossing of the sine wave at half of the logic supply voltage (VCC). The motor controller 408 (see FIG. 4) creates multiple signals from this output signal. An analog to digital converter (ADC) in the microcontroller reads the DC voltage to determine the actual line voltage present on L1 referenced to L2 and continually stores that value in a register in the processor allowing the software to always be able to access the most recent voltage measurement available. The software in the microprocessor generates a square wave signal that represents whether L1 is greater than L2 or L2 is greater than L1. For example, the microprocessor generates a high (or 1) for the voltage polarity sensor signal when the voltage on Line 1 is positive when referenced to Line 2 and generates a low (or 0) for the voltage polarity sensor signal when the voltage on Line 1 is negative when referenced to Line 2. The square wave is used to determine which mode the motor controller 408 needs to be operating in to generate the desired current flow through the motor. The software in the microprocessor used in motor controller 408 also generates a square wave signal that represents whether voltage is increasing or decreasing when viewed from the line voltage zero-crossing. This signal is used in conjunction with the actual voltage measurement by the software in the microprocessor to determine when the motor controller 408 needs to change modes to ensure the motor current stays in phase with BEMF of the motor.

FIGS. 16-18 depict an exemplary embodiment of a current sensor 324A. One side of a current sensor 324 is connected to one side of the windings Wa, e.g., point A 326 (see FIGS. 3-4) placing it in series with windings so that only the winding current is measured. The other side of the current sensor 324 is connected to the cathodes of the first diode D1A and the sixth diode D3B and the drains of the second DC power switch Q1B and the fifth DC power switch Q3A (see FIGS. 3-4). Having the current sensor 324A in this location allows there to always be an accurate measurement of the current in the windings Wa without picking up any current from power supplies or other sources. C4 is the bypass capacitor used to prevent noise coming into the current sensor 324A from VCC and also prevents noise from being injected into VCC caused by the changing current draw used by the current sensor 324A. C5 coupled with the internal 1.8 kOhm resistance in the current sensor 324A, creates an RC filter that is applied to the output waveform. The RC filter limits the bandwidth to achieve better resolution at lower current frequencies. The current sensor 324A feeds the current value through R11 into the feedback loop of an op-amp with a zero current value of ½ VCC. One side of this feedback loop connects to the inverting input of an op-amp while the other side feeds into an RC filter comprised of R14 and C7. The value of R14 adjusts the amplitude of the output of the op-amp in relation to the output of the current sensor 324A. For ex, if R14 has twice the value of R11, the signal coming out of the op-amp will have twice the amplitude of the signal coming out of the current sensor 324A. Once the desired amplitude has been achieved, the value of C7 is determined to filter the output waveform to the desired frequency range. The non-inverting input of the op-amp is connected to the output of a secondary op-amp. The secondary op-amp utilizes R12 and R13 as a voltage divider to create a clean DC voltage that is equal to ½ VCC. One side of R12 is connected to VCC and the other side is connected to R13 and the non-inverting input of the secondary op-amp. The other side of R13 is connected to ground. If R12 and R13 have the same resistance the non-inverting input of the secondary op-amp will be at ½ VCC. The inverting input of the secondary op-amp is connected directly to the output of the secondary op-amp to create a feedback loop that will always hold the output voltage at ½ VCC. Capacitor C6 is used to filter the output of the secondary op-amp. The output of the secondary op-amp being at ½ VCC and connected to non-inverting input of the primary op-amp ensures that the amplified and filtered signal coming out of the primary op-amp has a zero current measurement of ½ VCC.

### Non-Synchronous Control

A non-synchronous control of the multispeed AC machine circuit 302B of FIG. 9 may include aspects of the control techniques discussed above. The control techniques may include several registers corresponding to determined states or operations of the AC machine controlled by the AC machine control circuit 306A. Several readings or measurements of the performance of the AC machine may also be obtained, the values of which may be stored by the AC machine control circuit 306A for use in controlling aspects or operation the AC machine circuit 302B. The control techniques described below may improve several aspects of the operation of the AC machine circuit 302B.

In one implementation, the Hall effect sensor signal can be shifted by the motor controller or a new hall effect sensor signal may be generated to provide improved performance, such as during a start-up period of the AC machine circuit 302B. For example, upon startup the Hall effect sensor signal may be monitored and, if the signal has not changed in a particular number of cycles of a routine, a new Hall effect sensor signal may be generated that is the inverse of the Hall effect sensor signal. This new Hall effect sensor signal may cause the rotation of the AC machine to change directions and rock the AC machine out of a lockup state and start spinning. This process of monitoring the Hall effect sensor signal and generating the new Hall effect sensor signal may repeat, perhaps based on a count of an execution of a startup loop, until the AC machine begins spinning.

In another implementation, one or more speed measurements of the AC machine may be obtained by the AC machine control circuit 306A and stored in a computer-readable medium for use by the control circuit. The one or more speed measurements of the AC machine may be based on the Hall effect sensor signal discussed above. For example, the control circuit 306A may determine a stability of the Hall effect sensor signal, such as through tracking a count of an executed process to determine if the Hall effect sensor signal is maintained for a threshold number of counts. Upon a high Hall effect sensor signal being sustained at a value for the threshold number of counts of the process, a timer value may be recorded in a first speed time register and the timer may continue. A similar process may occur for a low Hall effect sensor signal being sustained at a low value for the threshold number of counts of the process, upon which the timer value may be recorded in a second time register. This process may occur on each edge of the Hall effect sensor signal such that each edge of the Hall signal has a register which stores the last two samples of speed. The values in the time registers may be averaged together, then the two averages may be averaged together to create an average Hall time value. Each of the above discussed values may be updated on every edge of the Hall effect sensor signal.

A similar process may be executed to obtain a speed measurement based on the new Hall effect sensor signal or a shifted Hall effect sensor signal. In one implementation, the control circuit 306A may determine if the average Hall time value calculated above is below a speed value. If yes, the new Hall effect sensor signal is used, otherwise the shifted Hall effect sensor signal is used. Based on the selected Hall effect sensor signal, a timer value may be stored when and edge of the selected Hall effect sensor signal is determined as described above. From the stored timer values, an average slow Hall time value may be calculated and stored. These and other speed measurements may be utilized by the control circuit 306A to control operation of components or aspects of the AC machine circuit 302B, as explained in more detail below.

In some implementations, the control circuit 306A may generate a current reference waveform to control current flow through the AC machine circuit 302B. In one particular implementation, the current reference waveform may be a triangle wave, although other types of waveforms are contemplated. To generate the current reference waveform, the control circuit 306A may calculate a size of the divisions of the waveform and a number of the divisions. In one instance, the division size may be determined from the equation current_div=(average slow Hall time value)/(peak current of the AC machine circuit*2). The number of divisions may further be calculated, in one instance, through the equation (first timer value/current_div).

In some instances, a current reference value may be determined and used to generate this current reference waveform. In one particular instance, an analog-to-digital converter (ADC) sampling device may obtain voltage and/or current measurements of the signal through the motor windings Wa (or across Point A 326 and Point B 328). The control circuit 306A may determine a timer value corresponding to a zero-crossing point for the signal. In another implementation, the control circuit 306A may set the value for the zero-crossing point for the generated current reference waveform. To avoid an overflow condition, the current reference value may be set based on the calculated size of the number of divisions and on the value of the shifted Hall effect sensor signal. In particular, while the shifted Hall effect sensor signal is low, the current reference value grows with the number of divisions up to a peak of the zero-crossing point plus the peak current of the AC machine circuit. When the current reference value reaches this value, the current reference value may decrease down to the zero-crossing point. Alternatively, while the shifted Hall effect sensor signal is high, the current reference value decreases from the zero-crossing point to a peak of the zero-crossing point minus the peak current of the AC machine circuit, then increasing back up to the zero-crossing point. The sum of these conditions generates the triangle current waveform, alternating from the peak of the zero-crossing point plus the peak current of the AC machine circuit to the peak of the zero-crossing point minus the peak current of the AC machine circuit. This generated current reference waveform may be used in instances in which a current sensor is not used in AC machine circuit 302B. Rather, the control circuit 306A may control the operations of the power switches based on the generated current reference waveform, as described above with reference to FIG. 9.

The control circuit 306A may control the AC machine circuit 302B in a plurality of switching schemes, as indicated above. In one implementation, the switching schemes may include a synchronous switching scheme (in which the power switches are controlled synchronously) or a non-synchronous switching scheme (in which the power switches are controlled based on a truth table). The control scheme may be controlled by a synchronous flag bit. The synchronous flag bit may be set high (or asserted or assigned a value of “1”) in circumstances in which a set speed of the AC motor is of a particular value is maintained for a particular number of counts. The synchronous flag bit may also be set high based on the average Hall time value calculated above maintained within a range of a speed hysteresis value. Once the synchronous flag bit is asserted, de-assertion of the synchronous flag bit may occur based on a change to the set speed of the AC motor, the average Hall time value varies outside the range of the speed hysteresis value, or the PWM signal falls outside of a determined duty cycle.

During synchronous switching, the power switches (Q1A, Q1B, Q2A, Q2B, Q3A, Q3B, Q4A, Q4B) of the AC machine circuit 302B may be based on the shifted Hall effect sensor signal discussed above and a voltage positive signal. The voltage positive signal may be based on the ADC sampling circuit and is asserted when the voltage is sampled as a positive value. Otherwise, the voltage positive signal may be de-asserted. In general, the power switches are assigned an operating value one time and may not change unless the motor drops out of synchronous operating mode (as controlled by the synchronous flag bit). The motor controller 408 switching operations for this operating mode are shown in Table 21.

TABLE 21

| Shifted_hall | Voltage_positive | Q1A | Q1B | Q2A | Q2B | Q3A | Q3B | Q4A | Q4B |
|---|---|---|---|---|---|---|---|---|---|
| 0 | 0 | 0 | 0 | 1 | 1 | 1 | 1 | 0 | 0 |
| 1 | 0 | 1 | 1 | 0 | 0 | 0 | 0 | 1 | 1 |
| 0 | 1 | 1 | 1 | 0 | 0 | 0 | 0 | 1 | 1 |
| 1 | 1 | 0 | 0 | 1 | 1 | 1 | 1 | 0 | 0 |

In the non-synchronous switching scheme, the power switches may be controlled based on signals or values stored in a register by the control circuit 306A. In one particular implementation, the states of the power switches may be based on a current reference positive flag (asserted when the ADC current reading is a positive value), the voltage positive flag, a hysteresis band signal, and a hysteresis band positive signal. The hysteresis band signal may be set to zero, unless the ADC current reference value or the voltage reference value is equal to the zero-crossing point for the motor signal, in which case the hysteresis band signal may be set to one or otherwise asserted. The hysteresis band positive signal may be set to zero or de-asserted if the current reference value is less than the current value of the motor signal. Otherwise, the hysteresis band positive value may be set to one or otherwise asserted. In the non-synchronous operating mode, the motor controller 408 switching operations may occur as shown in Table 22.

TABLE 22

| Current | Hysteresis | | | | | | | | | | |
|---|---|---|---|---|---|---|---|---|---|---|---|
| Reference | Band | Voltage | Hysteresis | | | | | | | | |
| Positive | Positive | Positive | Band | Q1A | Q1B | Q2A | Q2B | Q3A | Q3B | Q4A | Q4B |
| 0 | 0 | 0 | 0 | 0 | 1 | 1 | 0 | 0 | 0 | 0 | 1 |
| 1 | 0 | 0 | 0 | 1 | 0 | 0 | 1 | 0 | 0 | 0 | 0 |
| 0 | 1 | 0 | 0 | 0 | 1 | 1 | 0 | 0 | 0 | 0 | 0 |
| 0 | 0 | 1 | 0 | 0 | 1 | 1 | 0 | 1 | 0 | 0 | 0 |
| 0 | 0 | 0 | 1 | 0 | 1 | 1 | 0 | 0 | 0 | 0 | 0 |
| 1 | 1 | 0 | 0 | 1 | 0 | 0 | 1 | 0 | 1 | 1 | 0 |
| 1 | 0 | 1 | 0 | 1 | 0 | 0 | 1 | 0 | 0 | 0 | 0 |
| 1 | 0 | 0 | 1 | 1 | 0 | 0 | 1 | 0 | 0 | 0 | 0 |
| 0 | 1 | 1 | 0 | 0 | 1 | 1 | 0 | 0 | 0 | 0 | 0 |
| 0 | 1 | 0 | 1 | 0 | 1 | 1 | 0 | 0 | 0 | 0 | 0 |
| 0 | 0 | 1 | 1 | 0 | 1 | 1 | 0 | 0 | 0 | 0 | 0 |
| 1 | 1 | 1 | 0 | 1 | 0 | 0 | 1 | 0 | 0 | 0 | 0 |
| 1 | 1 | 0 | 1 | 1 | 0 | 0 | 1 | 0 | 0 | 0 | 0 |
| 1 | 0 | 1 | 1 | 1 | 0 | 0 | 1 | 0 | 0 | 0 | 0 |
| 0 | 1 | 1 | 1 | 0 | 1 | 1 | 0 | 0 | 0 | 0 | 0 |
| 1 | 1 | 1 | 1 | 1 | 0 | 0 | 1 | 0 | 0 | 0 | 0 |

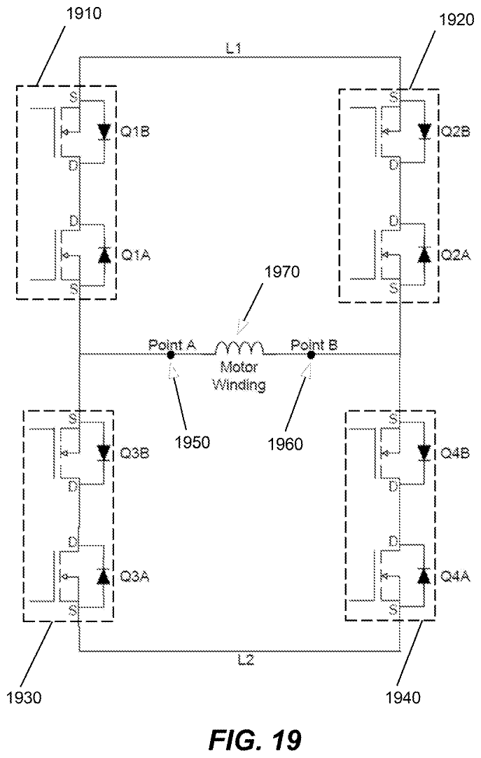

FIG. 19 depicts an exemplary embodiment of a multispeed alternating current (AC) machine circuit. The circuit depicted includes DC power switches Q1A, Q1B, Q2A, Q2B, Q3A, Q3B, Q4A, and Q4B. Pairs of DC power switches form bi-directional power switches. For example, DC power switches Q1A and Q1B form bi-directional power switch Q1 1910. DC power switches Q2A and Q2B form bi-directional power switch Q2 1920. DC power switches Q3A and Q3B form bi-directional power switch Q3 1930. DC power switches Q4A and Q4B form bi-directional power switches Q4 1940. Each pair of DC power switches are configured in series. For example, Q1A is configured in series with Q1B, Q2A is configured in series with Q2B, Q3A is configured in series with Q3B, and Q4A is configured in series with Q4B. In some embodiment, some of the bi-directional power switches may be configured in series while other bi-directional power switches in the same circuit may be configured in parallel.

The first side lead L1 and second side lead L2 are shown in FIG. 19. Furthermore, FIG. 19 depicts the connection of the bi-directional power switches Q1 1910, Q2 1920, Q3 1930, and Q4 1940 to the motor winding 1970 at Point A 1950 and Point B 1960.

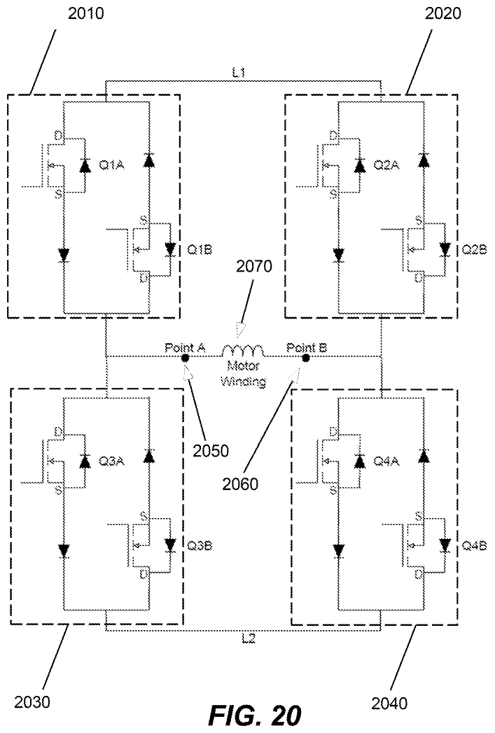

FIG. 20 depicts another exemplary embodiment of a multispeed alternating current (AC) machine circuit. The circuit depicted includes DC power switches Q1A, Q1B, Q2A, Q2B, Q3A, Q3B, Q4A, and Q4B. Pairs of DC power switches form bi-directional power switches. For example, DC power switches Q1A and Q1B form bi-directional power switch Q1 2010. DC power switches Q2A and Q2B form bi-directional power switch Q2 2020. DC power switches Q3A and Q3B form bi-directional power switch Q3 2030. DC power switches Q4A and Q4B form bi-directional power switches Q4 2040. Each pair of DC power switches are configured in parallel. For example, Q1A is configured in series with Q1B, Q2A is configured in series with Q2B, Q3A is configured in series with Q3B, and Q4A is configured in series with Q4B. In some embodiment, some of the bi-directional power switches may be configured in series while other bi-directional power switches in the same circuit may be configured in parallel.

The first side lead L1 and second side lead L2 are shown in FIG. 20. Furthermore, FIG. 20 depicts the connection of the bi-directional power switches Q1 2010, Q2 2020, Q3 2030, and Q4 2040 to the motor winding 2070 at Point A 2050 and Point B 2060.

Both circuits depicted in FIG. 19 and FIG. 20 require four (4) isolated gate drive power supplies. Two of the isolated gate drive power supplies required by FIG. 20 may be tied to line voltage terminals that do not switch rapidly. The two other isolated gate drive power supplies may be connected to motor terminals with rapid changes in common-mode voltage. This configuration may potentially reduce cross-talk among subcircuits.

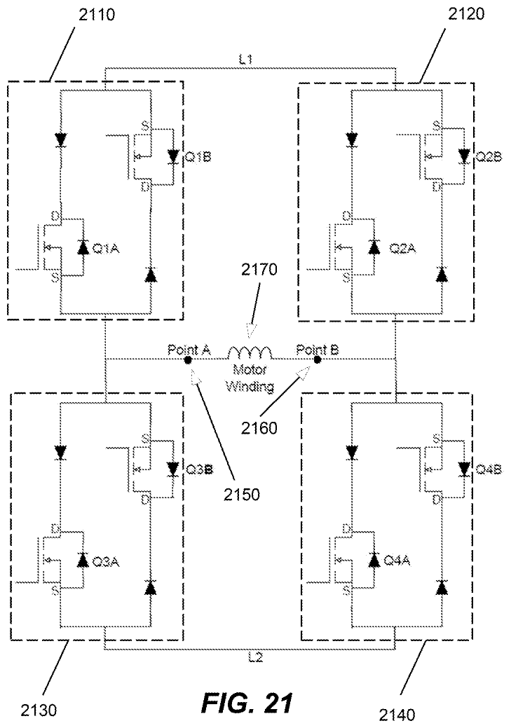

FIG. 21 depicts another exemplary embodiment of a multispeed alternating current (AC) machine circuit. The circuit depicted includes DC power switches Q1A, Q1B, Q2A, Q2B, Q3A, Q3B, Q4A, and Q4B. Pairs of DC power switches form bi-directional power switches. For example, DC power switches Q1A and Q1B form bi-directional power switch Q1 2110. DC power switches Q2A and Q2B form bi-directional power switch Q2 2120. DC power switches Q3A and Q3B form bi-directional power switch Q3 2130. DC power switches Q4A and Q4B form bi-directional power switches Q4 2140. Each pair of DC power switches are configured in parallel. For example, Q1A is configured in series with Q1B, Q2A is configured in series with Q2B, Q3A is configured in series with Q3B, and Q4A is configured in series with Q4B. In some embodiment, some of the bi-directional power switches may be configured in series while other bi-directional power switches in the same circuit may be configured in parallel.

The first side lead L1 and second side lead L2 are shown in FIG. 21. Furthermore, FIG. 21 depicts the connection of the bi-directional power switches Q1 2110, Q2 2120, Q3 2130, and Q4 2140 to the motor winding 2170 at Point A 2150 and Point B 2160.

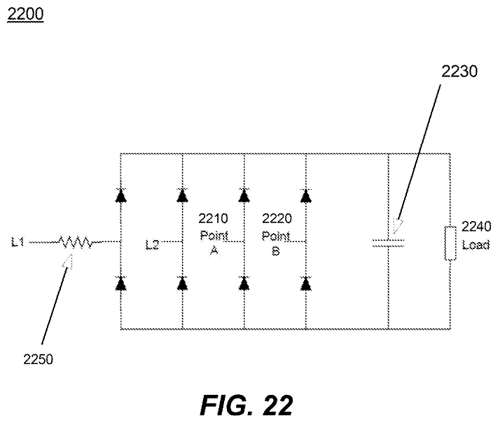

FIG. 22 depicts another embodiment of a multispeed alternating current (AC) machine circuit. The first side lead L1 and second side lead L2 are shown. A resistor 2250 may be included in series with the first side lead L1. Furthermore, Point A 2210 and Point B 2220 are shown, where each Point A 2210 and Point B 2220 are located in parallel to each other and in series with two diodes. Energy transferred to the capacitor 2230 shown in FIG. 22 from interrupting motor current may be used for control power. This may improve efficiency. The load 2240 is also shown in FIG. 22.

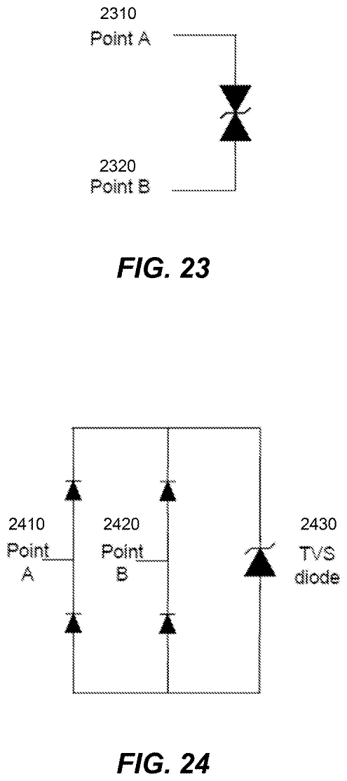

FIGS. 23-24 depict exemplary embodiments of clamp circuits, or voltage clamp circuits, for motor voltage. The clamp circuits shown in FIGS. 23-24 may be added across motor terminals.

Because motors are an inductive load, they require a voltage clamp circuit to prevent overvoltage if the motor current is interrupted. This interruption may occur due to a disruption of line power. The interruption may also occur during normal operation of the circuit. The circuit shown in FIG. 23 may use energy transferred to a capacitor from interrupting motor current to control power. This may improve efficiency. The circuit shown in FIG. 24 may reduce the required number of parts and remove a link between motor terminal overvoltage and capacitor overvoltage. This may eliminate a failure mechanism.

In other embodiments, the disclosure herein includes methods for providing the components described herein for a machine, including for a motor or a generator.

In other embodiments, the disclosure herein includes methods for connecting the components described herein for a machine, including for a motor or a generator.

Those skilled in the art will appreciate that variations from the specific embodiments disclosed above are contemplated by the invention. The invention should not be restricted to the above embodiments.

What is claimed is:

1. A circuit for a machine having an alternating current (AC) power source having a first side (L1) and a second side (L2), the circuit comprising:
at least one winding with a start side and an end side;
a first bi-directional power switch connected between the first side of the AC power source and the winding start side, the first bi-directional power switch comprising a first direct current (DC) power switch and a second DC power switch configured in opposite current passing directions;
a second bi-directional power switch connected between the first side of the AC power source and the winding end side, the second bi-directional power switch comprising a third DC power switch and a fourth DC power switch configured in opposite current passing directions;
a third bi-directional power switch connected between the second side of the AC power source and the winding start side, the third bi-directional power switch comprising a fifth DC power switch and a sixth DC power switch configured in opposite current passing directions;
a fourth bi-directional power switch connected between the second side of the AC power source and the winding end side, the fourth bi-directional power switch comprising a seventh DC power switch and an eighth DC power switch configured in opposite current passing directions;
a Hall effect sensor to detect a position of a rotor of the machine relative to a stator of the machine and output a first signal indicating the position of the rotor relative to the stator;
a voltage polarity sensor to detect whether voltage from the AC power source is higher at the first side of the AC power source or the second side of the AC power source and output a second signal indicating whether the voltage is higher at the first side of the AC power source or the second side of the AC power source; and
a motor controller configured to:
receive the first signal from the Hall effect sensor and the second signal from the voltage polarity sensor;
determine based on the first signal and the second signal a first direction of current flow through the winding and a second direction of current flow from the first side of the AC power source to the second side of the AC power source or from the second side of the AC power source to the first side of the AC power source; and
control the DC power switches to obtain the determined first direction of current flow through the winding and the determined second direction of current flow from the first side of the AC power source to the second side of the AC power source or from the second side of the AC power source to the first side of the AC power source.

2. The circuit of claim 1, wherein the motor controller is configured to transmit a plurality of control signals to one or more DC power switch to control the DC power switches to obtain the determined first direction of current flow through the winding and the determined second direction of current flow from the first side of the AC power source to the second side of the AC power source or from the second side of the AC power source to the first side of the AC power source.

3. The circuit of claim 1, wherein at a first time, the motor controller is configured to:
open or close a first one of the DC power switches of a bi-directional power switch but not control a second one of the DC power switches of the bi-directional switch;
open or close the second one of the DC power switches of the bi-directional power switch but not control the first one of the DC power switches of the bi-directional power switch;
open both the first one of the DC power switches and the second one of the DC power switches in the bi-directional power switch; or
close both the first one of the DC power switches and the second one of the DC power switches in the bi-directional power switch.

4. The circuit of claim 1, wherein the motor controller is configured to close one pair of bi directional power switches while switching each of the DC power switches on, off, or in pulse-width modulation to allow current to continue flowing in one direction until a voltage difference drives the current in an opposite direction.

5. The circuit of claim 1, wherein the motor controller closes one pair of bi-directional power switches while switching each of the DC power switches on, off, or in pulse-width modulation to drive current in an opposite direction.

6. The circuit of claim 1, wherein the motor controller is configured to:
determine, based on the first signal and the second signal, one or more DC power switches to open or close or operate in pulse-width modulation (PWM) to obtain the determined first direction of current flow through the winding and the determined second direction of current flow from the first side of the AC power source to the second side of the AC power source or from the second side of the AC power source to the first side of the AC power source; and
transmit a plurality of control signals to the DC power switches to open one or more of the DC power switches, close one or more of the DC power switches, and operate at least one of the DC power switches in pulse-width modulation (PWM) to cause the current to flow in the determined first direction through the winding and cause the current to flow in the determined second direction either from the first side of the AC power source to the second side of the AC power source or from the second side of the AC power source to the first side of the AC power source.

7. The circuit of claim 1, wherein the Hall effect sensor is configured to:
detect a polarity of a magnet of the rotor of the machine relative to the stator of the machine;
output a high value for the first signal when a north magnetic pole of the magnet of the rotor is facing the stator; and
output a low value for the first signal when a south magnetic pole of the magnet of the rotor is facing the stator.

8. The circuit of claim 1, wherein the second signal from the voltage polarity sensor has a high value when a voltage on the first side of the AC power source is higher than a voltage on the second side of the AC power source and has a low value when the voltage on the first side of the AC power source is lower than the voltage on the second side of the AC power source.

9. The circuit of claim 1, wherein each of the DC power switches in each bi-directional switch are configured in parallel with a diode.

10. The circuit of claim 1, wherein the DC power switches in each bi-directional switch are configured in series.

11. The circuit of claim 1, wherein operating one of the DC power switches in pulse width modulation includes repeatedly turning the one of the DC power switches on and off at a selected duty cycle for a total period of time.

12. The circuit of claim 11, wherein the motor controller is configured to:
continuously determine an actual duty cycle at the one of the DC power switches,
compare the actual duty cycle to a desired duty cycle, and
increase or decrease at least one of an on-period of time or an off-period of time of the one of the DC power switches to achieve the desired duty cycle.

13. The circuit of claim 1, wherein the motor controller operates one or more of the DC power switches in pulse with modulation (PWM) by transmitting PWM control signals to the selected DC power switches, wherein the PWM control signals include a duty cycle.

14. The circuit of claim 1, wherein the motor controller increases an advance value of the Hall effect signal.

15. The circuit of claim 1, wherein the motor controller is configured to change a switching mode.

16. The circuit of claim 1, wherein the motor controller is configured to operate the circuit in synchronous mode by:
closing one pair of the first bi-directional power switch and the fourth bi-directional power switch and opening another pair of the second bi-directional power switch and the third bi-directional power switch, or
opening the one pair and closing the other pair.

17. The circuit of claim 1, wherein the circuit operates in a starting mode, a synchronous speed mode, or an off-synchronous speed mode.

18. The circuit of claim 17, wherein off-synchronous speed operation is operation at a speed that is less than synchronous speed or more than synchronous speed.

19. The circuit of claim 1, wherein the motor controller is configured to operate in a delayed firing angle with zero current shutoff by waiting until a sine wave of a voltage is past a point before closing any DC power switches.

20. The circuit of claim 1, wherein the motor controller is configured to operate in delayed firing angle with zero current shutoff by:
closing one pair of the first bi-directional power switch and the fourth bi-directional power switch or another pair of the second bi-directional power switch and the third bi directional power switch when voltage is at a peak of a sine wave, and
when current flow through the winding is at zero, opening all DC power switches and waiting until a next peak of the sine wave is reached before closing any DC power switches.

21. The circuit of claim 1, further comprising a direct current (DC) power supply to receive alternating current (AC) power transferred from the AC power source, convert the AC power to DC power, and transfer the DC power to one or more components of the circuit.

22. The circuit of claim 1, wherein the motor controller comprises at least one of a processor, an application specific integrated circuit (ASIC), a field programmable gate array signal (FPGA), s programmable logic device (PLD), gate logic, and transistor logic.

23. The circuit of claim 1, wherein each DC power switch includes a MOSFET.

24. The circuit of claim 1, wherein the Hall effect sensor is mounted to a holder mounted to a tripod, and the tripod is mounted to a stator of the machine.

25. The circuit of claim 1, wherein the machine is a motor or a generator.

26. A circuit for a machine having an alternating current (AC) power source having a first side (L1) and a second side (L2), the circuit comprising:
at least one winding with a start side and an end side;
a first bi-directional power switch connected between the first side of the AC power source and the winding start side, the first bi-directional power switch comprising a first DC power switch and a second DC power switch configured in opposite current passing directions;
a second bi-directional power switch connected between the first side of the AC power source and the winding end side, the second bi-directional power switch comprising a third DC power switch and a fourth DC power switch configured in opposite current passing directions;
a third bi-directional power switch connected between the second side of the AC power source and the winding start side, the third bi-directional power switch comprising a fifth DC power switch and a sixth DC power switch configured in opposite current passing directions;
a fourth bi-directional power switch connected between the second side of the AC power source and the winding end side, the fourth bi-directional power switch comprising a seventh DC power switch and an eighth DC power switch configured in opposite current passing directions; and
a motor controller configured to:
control the DC power switches to obtain a first direction of current flow through the winding from the start side to the end side or from the end side to the start side and a second direction of current flow from the first side of the AC power source to the second side of the AC power source or from the second side of the AC power source to the first side of the AC power source.

27. A circuit for a machine having an alternating current (AC) power source having a first side (L1) and a second side (L2), the circuit comprising:
at least one winding with a start side and an end side;
a voltage polarity sensor;
a Hall effect sensor;
four bi-directional power switches each comprising two DC power switches; and
a motor controller configured to:
based on signals from the voltage polarity sensor and the Hall effect sensor, open or close or operate with pulse-width modulation the DC power switches to obtain a first direction of current flow through the at least one winding and a second direction of current flow from the first side of the AC power source to the second side of the AC power source or from the second side of the AC power source to the first side of the AC power source.

28. A method for a machine having an alternating current (AC) power source having a first side (L1) and a second side (L2), the method comprising:
providing at least one winding with a start side and an end side;
providing a first bi-directional power switch connected between the first side of the AC power source and the winding start side, the first bi-directional power switch comprising a first DC power switch and a second DC power switch configured in opposite current passing directions;
providing a second bi-directional power switch connected between the first side of the AC power source and the winding end side, the second bi-directional power switch comprising a third DC power switch and a fourth DC power switch configured in opposite current passing directions;
providing a third bi-directional power switch connected between the second side of the AC power source and the winding start side, the third bi-directional power switch comprising a fifth DC power switch and a sixth DC power switch configured in opposite current passing directions;
providing a fourth bi-directional power switch connected between the second side of the AC power source and the winding end side, the fourth bi-directional power switch comprising a seventh DC power switch and an eighth DC power switch configured in opposite current passing directions;
providing a Hall effect sensor to detect a position of a rotor of the machine relative to a stator of the machine and output a first signal indicating the position of the rotor relative to the stator;
providing a voltage polarity sensor to detect whether voltage from the AC power source is higher at the first side of the AC power source or the second side of the AC power source and output a second signal indicating whether the voltage is higher at the first side of the AC power source or the second side of the AC power source; and
providing a motor controller configured to:
receive the first signal from the Hall effect sensor and the second signal from the voltage polarity sensor;
determine based on the first signal and the second signal a first direction of current flow through the winding and a second direction of current flow from the first side of the AC power source to the second side of the AC power source or from the second side of the AC power source to the first side of the AC power source; and
control the DC power switches to obtain the determined first direction of current flow through the winding and the determined second direction of current flow from the first side of the AC power source to the second side of the AC power source or from the second side of the AC power source to the first side of the AC power source.
